(19) United States
(12) Patent Application Publication
(10) Pub. No.: US 2010/0250409 A1
(43) Pub. Date: Sep. 30, 2010

(54) Computer-implemented method and system for posting journal entries to general ledger

(75) Inventors: John Savage, Fair Haven, NJ (US); Lucy Lyulkin, New Milford, NJ (US); Natalia Goudkova, North Bergen, NJ (US); Edward Granaghan, Cream Ridge, NJ (US); Callie Thomas, New Providence, NJ (US); Kurt Makse, New York, NY (US); Erin Sheehan, Long Beach, NY (US); Thomas Conneally, Brooklyn, NY (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AMERICAN INTERNATIONAL GROUP, INC., New York, NY (US)

(21) Appl. No.: 12/650,248

(22) Filed: Dec. 30, 2009

Related U.S. Application Data
(60) Provisional application No. 61/142,084, filed on Dec. 31, 2008.

(51) Int. Cl. G06Q 40/00; H04L 9/32; G06F 21/00

(52) U.S. Cl. 705/30; 726/7

(57) ABSTRACT

Embodiments of computer-implemented methods and systems for posting non-machine journal entries to a general ledger can help the user validate non-machine journal entries posted to the general ledger. A non-machine journal entry application can be operated on a web platform which can be operated to maintain recurrent entries, create new or correct existing entries, and validate entries before posting them to the general ledger system. Operating the non-machine journal entry application, a user can store and maintain recurring entries in a database; validate a journal batch before posting; post recurring entries; correct existing entries; track journal entry batches sent to the general ledger; report on types of journal entries and posting history; and verify recurring batch completeness from exception, summary and account detail reports. The application centralizes the data entry and collection processes, enforces strict validation and quality control rules, and provides control through management reporting in a web-based environment.

### CROSS-REFERENCE TO RELATED APPLICATIONS

This patent application claims the benefit of priority to U.S. Provisional Patent Application No. 61/142,084, filed on Dec. 31, 2008, and entitled “Computer-Implemented Method and System for Posting Journal Entries to General Ledger,” which is incorporated in its entirety herein by this reference.

### FIELD OF THE INVENTION

The present invention relates generally to computer-implemented methods and systems for posting journal entries to a general ledger and more particularly to computer-implemented methods and systems for manually posting journal entries to a general ledger that receives other journal entries automatically.

### BACKGROUND OF THE INVENTION

U.S. Pat. Nos. 5,117,356; 7,263,527; and 7,356,496 and U.S. Patent Application Publication Nos. US 2004/0111342; US 2005/0234786; and US 2007/0185791 are cited as background art. These references relate generally to computer-implemented methods and systems for maintaining an account ledger.

Financial data can flow into the general ledger through journal entries classified as either machine or non machine entries. Machine entries are those transactions which are system generated and require no manual intervention. These entries are automated transactions between various systems that are interfaced with each other as well as the general ledger. Non machine entries are those transactions that are manually posted to the general ledger. A non machine entry may be created in situations where there is no automatic process in place caused by a lack of system interface or as an adjustment which cannot be generated through the machine process. A non machine entry may be entered through a semi-automated process which requires only minimal manual intervention such as pooling and apportionment transactions, for example.

Machine and non machine entries can be categorized as self reversing or permanent transactions. Permanent entries are actual values (not estimates) or other entries that would have a permanent impact on the accounts. Self reversing entries are used to record transactions such as accruals, estimates and transactions that would otherwise be machine entries, made necessary after the general ledger cut-off. Non machine transactions can be entered through specific journal codes assigned to the various departments throughout the company maintaining the general ledger and can be supported by batch numbers that are used to identify the actual entry into the general ledger.

In the case where the company maintaining the general ledger is an insurance company, machine transactions can be generated by the underwriting systems, which in turn interface with the company's billings and collections (B & C) system and ultimately post to the general ledger. Non-machine entries can be initiated by various profit centers or the comptrollers department, for example. Examples of non machine entries include entries relating to the accrual of business booked in the last few days of each calendar quarter where direct posting to the general ledger is halted for quarter-end closing (pipeline).

Therefore, there is a need for computer-implemented methods and systems for posting non-machine journal entries to a general ledger that help support the validity of the non-machine journal entries made. There is also a need for computer-implemented methods and systems for posting non-machine journal entries to a general ledger that integrate documented policies and procedures, including supporting documentation requirements, for the processing of the transactions to allow the company to monitor the non-machine journal entries for compliance, accuracy, and reliability.

### BRIEF SUMMARY

Embodiments of computer-implemented methods and systems for posting non-machine journal entries to a general ledger are disclosed, which can help the user validate non-machine journal entries posted to the general ledger. A non-machine journal entry application can be operated on a web platform which can be operated to maintain recurrent entries, create new or correct existing entries, and validate entries before posting them to the general ledger system.

Operating the non-machine journal entry application, a user can store and maintain recurring entries in a database; validate a journal batch before posting; post recurring entries; correct existing entries; track journal entry batches sent to the general ledger; report on types of journal entries and posting history; and verify recurring batch completeness from exception, summary and account detail reports. The application centralizes the data entry and collection processes, enforces strict validation and quality control rules, and provides control through management reporting in a web-based environment.

The non-machine journal entry application allows the user to maintain and re-use the information stored in a centralized database. A built-in batch-naming mechanism can group similar types of entries together to provide an opportunity for reporting on various journal types.

Each non machine journal entry can include a cover page, a detailed journal entry, auditable supporting information and a transaction posting report. A preparer and an approver can apply an electronic signature to the auditable supporting information attached to the journal entry for completeness and accuracy. The non-machine journal entry can be part of a monthly reconciliation process to ensure that each entry is accounted for and accompanied by adequate documentation. A quality control department can conduct periodic examinations of a pool of randomly-selected non-machine journal entries to ensure that the procedure is being followed and that the recorded transactions are accurate and complete.

In one embodiment, a computer-implemented method for posting a non-machine journal entry to a general ledger includes accessing a non-machine journal entry application operated on an accounting processor. A non-machine journal entry is created using the non-machine journal entry application. The non-machine journal entry is electronically submitted for approval. The non-machine journal entry is reviewed for compliance with a set of requirements. If the non-machine journal entry complies with the set of requirements, the non-machine journal entry is electronically posted to a computer-implemented general ledger application.

In one embodiment, a computer-implemented system for posting a non-machine journal entry to a general ledger includes an accounting processor adapted to execute a general ledger application adapted to maintain a general ledger and to execute a non-machine journal entry application adapted to create non-machine journal entries and to selectively transmit non-machine journal entries to the general ledger. A data storage device is provided that contains accounting information. The data storage device is operably arranged with the accounting processor such that the account information in the storage device is accessible to the accounting processor via at least one of the general ledger application the non-machine journal entry application and is modifiable by the accounting processor. The non-machine journal entry application executed by the accounting processor includes a journal header module, a journal detail module, a cover sheet module, and a support module.

The journal header module is adapted for use to select a journal header from a set of journal header types. The journal detail module is adapted for use to enter journal detail information for the selected journal header. The cover sheet module is adapted for use to create a cover sheet. The support module is adapted for use to attach supporting documentation for the non-machine journal entry.

In one embodiment, a computer-readable storage medium having instructions stored thereon for creating and posting a non-machine journal entry to a general ledger is provided. The instructions, when executed by a computer, cause the computer to perform the steps of: selecting a journal header from a set of journal header types for the non-machine journal entry, associating journal detail information for the selected journal header with the non-machine journal entry, creating a cover sheet for the non-machine journal entry, attaching supporting documentation to the non-machine journal entry, and posting the non-machine journal entry to a computer-implemented general ledger.

### BRIEF DESCRIPTION OF THE DRAWINGS

FIG. 1 is a schematic diagram of an embodiment of a computer-implemented system for posting a non-machine journal entry to a general ledger.

FIG. 2 is a flow diagram showing an embodiment of a computer-implemented method for posting a non-machine journal entry to a general ledger.

FIG. 3 is a flow diagram showing an embodiment of a computer-implemented method for creating a non-machine journal entry for posting to a general ledger.

FIG. 4 is a screen shot of an embodiment of a graphical user interface of a login page for a computer-implemented system and method for posting a non-machine journal entry to a general ledger.

FIG. 5 is a screen shot of an embodiment of a graphical user interface of a login page for a computer-implemented system and method for posting a non-machine journal entry to a general ledger.

FIG. 6 is a screen shot of an embodiment of a graphical user interface of a home tab of a main page for a computer-implemented system and method for posting a non-machine journal entry to a general ledger.

FIG. 7 is a screen shot of an embodiment of a graphical user interface of a journal header tab of a main page for a computer-implemented system and method for posting a non-machine journal entry to a general ledger.

FIG. 8A is a screen shot of an embodiment of a graphical user interface in the form of a pop-up window for a first option from the journal header tab of FIG. 7.

FIG. 8B is a screen shot of an embodiment of a graphical user interface in the form of a pop-up window for a second option from the journal header tab of FIG. 7.

FIG. 8C is a screen shot of an embodiment of a graphical user interface in the form of a pop-up window for a third option from the journal header tab of FIG. 7.

FIG. 9 is a screen shot of an embodiment of a graphical user interface of a journal detail tab of a main page for a computer-implemented system and method for posting a non-machine journal entry to a general ledger.

FIG. 10 is a screen shot of an embodiment of a graphical user interface in the form of a pop-up window for an upload transaction details function from the journal detail tab of FIG. 9.

FIG. 11 is a screen shot of an embodiment of a journal entry template in the form of an Excel file accessed from the pop-up window of FIG. 10.

FIG. 12 is a screen shot of an embodiment of a graphical user interface in the form of a pop-up window for a processing status relating to the an upload transaction details function of the journal detail tab of FIG. 9.

FIG. 13 is a fragmentary screen shot of the pop-up window of FIG. 10.

FIG. 14 is a screen shot of an embodiment of a graphical user interface of a cover sheet tab of a main page for a computer-implemented system and method for posting a non-machine journal entry to a general ledger.

FIG. 15 is a screen shot of an embodiment of a graphical user interface of a support tab of a main page for a computer-implemented system and method for posting a non-machine journal entry to a general ledger.

FIG. 16 is a screen shot of an embodiment of a graphical user interface in the form of a drop-down box for a document type selection function from the cover sheet tab of FIG. 15.

FIG. 17 is a fragmentary screen shot of the graphical user interface of FIG. 15 showing additional information fields relating to the selection of an email as the document type.

FIG. 18 is a fragmentary screen shot of the graphical user interface of FIG. 15 showing additional information relating to supporting documentation uploaded for the NMJE.

FIG. 19 is a fragmentary screen shot of the graphical user interface of FIG. 15 showing a Finalize Journal Support and Entry button in an active state.

FIG. 20 is a screen shot of an embodiment of a graphical user interface in the form of a pop-up window for a select batch function from the support tab of FIG. 15.

FIG. 21A is a screen shot of an embodiment of a graphical user interface of a review tab of a main page for a computer-implemented system and method for posting a non-machine journal entry to a general ledger.

FIG. 21B is a fragmentary screen shot of the graphical user interface of FIG. 21A showing a Print Cover Sheet PDF button, a Delete Batch button, a Revise batch button, and a Submit for Approval Button in an active state.

FIG. 22 is a fragmentary screen shot of the graphical user interface of FIG. 21A showing an embodiment of a display for an Attached Supporting Documents field when no supporting documents are attached and the NMJE has been submitted for approval.

FIG. 23 is a fragmentary screen shot of the graphical user interface of FIG. 21A showing an embodiment of a status message after the NMJE has been successfully submitted for approval.

FIG. 24 is a screen shot of an embodiment of a non-machine journal entry cover sheet file for a computer-implemented system and method for posting a non-machine journal entry to a general ledger.

FIG. 25A is a screen shot of an embodiment of a graphical user interface of an approve tab of a main page for a computer-implemented system and method for posting a non-machine journal entry to a general ledger.

FIG. 25B is a screen shot of the graphical user interface of FIG. 25A showing detailed information for a batch selected for review and release.

FIG. 26 is a fragmentary screen shot of the graphical user interface of FIG. 25A showing an example of batches approved by an Approver.

FIG. 27 is a fragmentary screen shot of the graphical user interface of FIG. 25A showing an example of batches rejected by an Approver.

FIG. 28 is a screen shot of an embodiment of a graphical user interface of a send to general ledger tab of a main page for a computer-implemented system and method for posting a non-machine journal entry to a general ledger.

FIG. 29 is a screen shot of an embodiment of a graphical user interface in the form of a pop-up window for an FTP function from the send to general ledger tab of FIG. 28.

FIG. 30 is a screen shot of an embodiment of a graphical user interface in the form of a pop-up window for FTP scheduling information.

FIG. 31 is a screen shot of an embodiment of a graphical user interface of a reports tab of a main page for a computer-implemented system and method for posting a non-machine journal entry to a general ledger.

FIG. 32 is a screen shot of an embodiment of a non-machine journal entry process summary management report file for a computer-implemented system and method for posting a non-machine journal entry to a general ledger.

FIG. 33 is a screen shot of an embodiment of a non-machine journal entry quality control report file for a computer-implemented system and method for posting a non-machine journal entry to a general ledger.

FIG. 34 is a screen shot of an embodiment of a non-machine journal entry recurring entry completeness report file for a computer-implemented system and method for posting a non-machine journal entry to a general ledger.

FIG. 35 is a screen shot of an embodiment of a non-machine journal entry recurring entries (batch summary) report file for a computer-implemented system and method for posting a non-machine journal entry to a general ledger.

FIG. 36 is a screen shot of an embodiment of a non-machine journal entry recurring entries (batch account details) report file for a computer-implemented system and method for posting a non-machine journal entry to a general ledger.

FIG. 37 is a screen shot of an embodiment of a non-machine journal entry processing history summary report file for a computer-implemented system and method for posting a non-machine journal entry to a general ledger.

FIG. 38 is a screen shot of an embodiment of an embodiment of a graphical user interface in the form of a pop-up window for a detailed view of a batch selected from the non-machine journal entry processing history summary report file of FIG. 37.

FIG. 39 is a screen shot of an embodiment of a non-machine journal entry non-recurring entries report file for a computer-implemented system and method for posting a non-machine journal entry to a general ledger.

### DETAILED DESCRIPTION OF EMBODIMENTS OF THE INVENTION

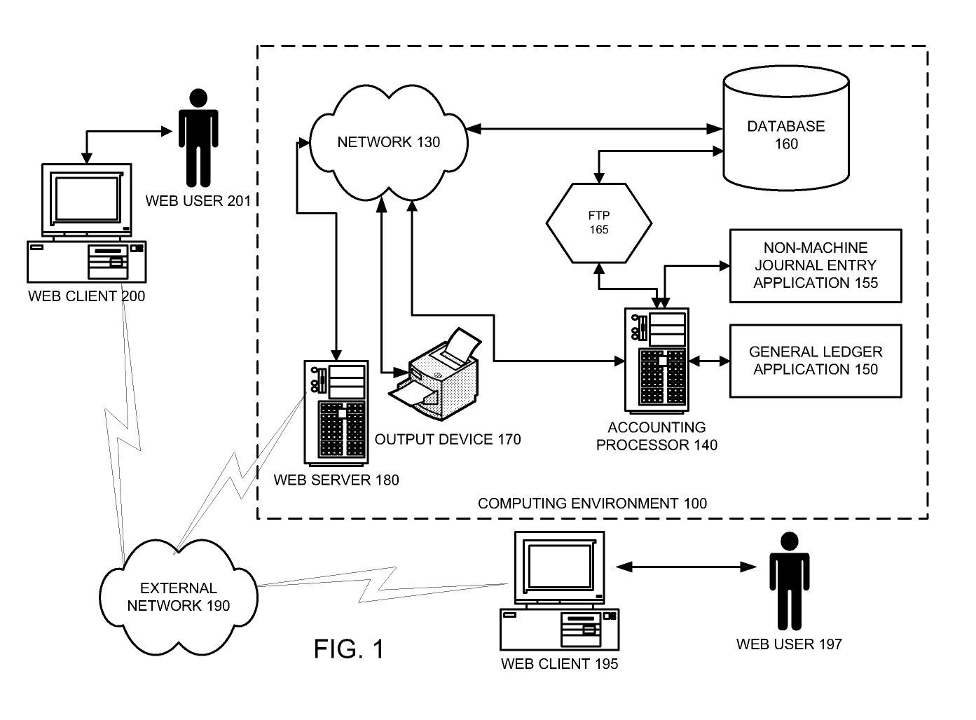

Turning now to the Figures, there is shown in FIG. 1 an embodiment of a computer-implemented system 100 for posting a non-machine journal entry to a general ledger. The web server 180 can provide access to an internet-based web platform that includes a non-machine journal entry (NMJE) application 155. The NMJE web platform is a centralized, front-end application for entering and sending manual journal entries into a computer-implemented general ledger application 150. The general ledger application 150 can be any suitable computer-implemented application for maintaining a company's general ledger, such as applications commercially available from AXS-One Inc. of Rutherford, N.J., including AXS-One's General Ledger module of its Enterprise suite of applications.

The computing environment 100 can include a number of computer systems, which generally can include any type of computer system based on: a microprocessor, a mainframe computer, a digital signal processor, a portable computing device, a personal organizer, a device controller, or a computational engine within an appliance. More specifically, the computing environment 100 can include an internal network 130, an accounting processor 140, a general ledger application 150, a non-machine journal entry application 155, a database 160, a file transfer protocol (FTP) server 165, an output device 170, and a web server 180 operatively connected to an external network 190. The input device 110, the accounting processor 140, the databases 160, the output device 170, and the web server 180 are operatively connected together via the internal network 130. A plurality of web clients 195, 200 can use the computing environment 100 to access the NMJE application 155 to enter non-machine journal entries in the general ledger maintained by the general ledger application 150.

The network 130 can generally include any type of wired or wireless communication channel capable of coupling together computing nodes. This includes, but is not limited to, a local area network, a wide area network, or a combination of networks.

The accounting processor 140 can generally include any computational node including a mechanism for servicing requests from a client for computational resources, data storage resources, or a combination of computational and data storage resources. Furthermore, the accounting processor 140 can generally include any system that can be adapted to allow for the selective transmission of non-machine journal entries from the NMJE application 155 to the general ledger. The accounting processor 140 can generally include any component of an application that can receive input from the web users 197, 201, process the input, and present the output to the general ledger application 150, the web server 180, and/or the database 160. The accounting processor 140 can generally include any component of an application that can process data, interact with the database 160, and execute business logic for the administration of the general ledger.

A report engine can be provided to generate displays of information stored in the database 160 concerning the general ledger, which can be viewed using the output device 170, for example. In one embodiment, the report engine further provides pre-configured and/or ad hoc reports relating to the general ledger and the non-machine journal entries entered in the general ledger.

The database or data storage device 160 can generally include any type of system for storing data in non-volatile storage. This includes, but is not limited to, systems based upon: magnetic, optical, and magneto-optical storage devices, as well as storage devices based on flash memory and/or battery-backed up memory.

The database 160 is operatively arranged with the processor 140 via the FTP server 165. In one embodiment, the database 160 contains information for entry in the general ledger. This information can be used by the general ledger application 150 and the NMJE application 155.

The output device 170 can comprise a printer, a display monitor, and a connection to another device, for example. The output device 170 can be used to generate reports for sending to the web users 197, 201 information about the general ledger and the NMJEs.

The web server 180 can provide a suitable web site or other Internet-based graphical user interface which is accessible by the web users 197, 201 for example. The web clients 195, 200 can be connected to the web server 180 through a network connection (e.g., Internet, Intranet, LAN, WAN and the like). The web server 180 can use an authentication server in order to validate and assign proper permissions to authorized users of the system. A permission database can store user credentials and permissions specific to each user. The web server 180 can be outfitted with a firewall such that requests originating from outside the computing environment pass through the firewall before being received and processed at the web server 180.

In addition to the components discussed above, the computing environment 100 can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

The system can include at least one input device operatively connected to at least one processor, at least one output device operatively connected to at least one processor, an internal network operatively connected to at least one processor, and an external network operatively connected to at least one processor.

The NMJE web platform can be used to post manual journal entries into the general ledger module. The types of non-machine journal entries that can be posted include: a recurring entry, a non-recurring entry, and a correcting entry. The NMJE web platform can help to consolidate the non-machine journal entries into a centralized database for posting into the general ledger. The NMJE web platform can help standardize the documentation and validation of manual journal entries into the general ledger. The NMJE web platform can assist in the quarter close process and help internal and external auditors perform reviews. The system offers simplified workflow while insuring data integrity and corresponding with accounting quarter closing procedures.

The NMJE application 155 does not require local installation on the user computer. A URL can be provided to access the NMJE Web Platform web site. The upload template can be downloaded to the local user drive from a template located on the web server 180. To provide enhanced security to the website, a login accessing feature can be provided that requires a user to perform a login step before the server allows access to the web platform.

The NMJE application 155 can be implemented using any suitable development tools, including Active Server Pages (ASP), Microsoft SQL Server and Excel, SAS, PERL, and Visual Basic (VB), for example. All application functionalities can be implemented in ASP (Active Server Pages), SAS, and PERL utilizing SQL Server database. The upload functionality can be based on an Excel file template saved in CSV (comma delimited) or TXT (tab delimited) format. File transfer scheduling (FTP) can employ the PERL scripting command. The Login validation can utilize Visual Basic executable. The system can include supporting documents upload and electronic signature approval functions. Function availability can be defined based on predetermined user roles: Preparer, Approver, Administrator, and Auditor, for example.

The NMJE application 155 can include a Login module, a Journal Header module, a Journal Detail module, a Cover Sheet module, a Support module, a Review module, an Approval module, a Submission module, a Reports module, a Help module, and an Administration module. A user can navigate through the modules of the NMJE application 155 through the use of a plurality of graphical user interfaces to perform a computer-implemented method for posting a non-machine journal entry to a general ledger.

In the Login module, a user can access the non-machine journal entry application upon the entry of an authorized identification and an associated password. The user's access to different modules of the non-machine journal entry application can vary depending upon the user's authority status.

In the Journal Header module, a preparer can create a Journal Header from three available options: (1) Select or Correct a Recurring Entry; (2) Create a Non-Recurring Journal Entry; and (3) Correct a Non-Recurring Journal Entry.

In the Journal Details module, the journal detail information for a selected header type can be entered. Transaction information can be typed in with the help of the preloaded auto-complete lists. If existing entry information is available, the application displays transaction detail records, and the preparer can modify pre-loaded fields and records. Transaction details can also be uploaded from a user-prepared file. The Journal Details module can include additional functionality in which an inter-company offset is automatically prepared by constructing a balancing company offset entry. The data entry process can be further enhanced by including an Insert Blank Row function, a Remove Selected Rows function, and a Replicate Last Record function. A Save Changes function allows the preparer to preserve entered information for later use. A Verify Information function allows for data entry validation, including company-branch-division verification, division and account confirmation, and debits and credits validation. An Export Detail Transactions function can allow the preparer to save the current entry in Excel format for future use.

In the Cover Sheet module, a cover sheet for the NMJE is prepared. To complete a NMJE, the preparer can be required to fill out a Purpose of Journal Entry field. Additional information about the NMJE can be provided in additional data fields.

In the Support module, the preparer can attach supporting documentation for the non-machine entry to the NMJE. Each NMJE can be required to include supporting documentation before it can be posted to the general ledger. In the support module, the preparer can complete data fields to describe all related documents and attach supporting files.

In the Review module, the preparer can select from three types of entries: (1) batches not sent for approval; (2) batches pending approval; and (3) rejected batches. For each journal entry included in batches not sent for approval, the preparer can print or preview the associated cover sheet, submit the entry for approval, delete the entry, or revise the entry. For entries pending approval, the preparer can only preview the cover sheet created in PDF reader. For rejected entries, the user has the option of previewing the cover sheet, deleting the entry, or revising the entry.

In the Approval module, an approver can review batches of entries submitted for approval. The Approver can review each entry along with its attached supporting documentation and either approve or reject the entry for submission to the general ledger depending upon its compliance with a set of predetermined requirements. The Approver can indicate his approval by using an electronic signature of approval.

In the Submission module, approved NMJEs can be posted to the General Ledger. The preparer will be able to view a list of approved NMJEs on the Submission module. Once a NMJE is successfully sent for posting to general ledger, it will be removed from the list of approved NMJEs.

In the Reports module, the user can generate reports concerning the process of posting of NMJEs. Examples of reports concerning the NMJE process include a Summary Management Report, Quality Control Reports; Correcting Entries Reports; a Daily Activity Report; an Additional Postings Report; a FTP History Report.

In the Help module, the user can access a plurality of help documents. The help documents can help enhance the user's ability to perform the process for posting NMJEs to the general ledger.

In the Administration module, an Administrator can access administrative utilities to help maintain the NMJE application. Examples of administrative utilities include: Recurring Header Maintenance, User/Sub-Department Maintenance, LockDown Maintenance, and Approver/Sub-Department Maintenance.

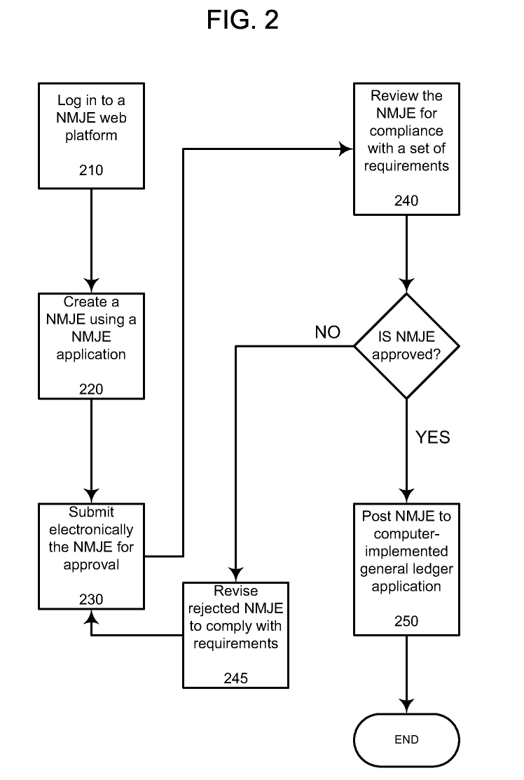

Referring to FIG. 2, an embodiment of a computer-implemented method for posting a non-machine journal entry to a general ledger is shown. In step 210, a user can log in to a NMJE web platform. The user authorized to act as a Preparer can operate a NMJE application through the web platform to create a NMJE in step 220. In some embodiments, the NMJE application can be used to create a journal header for the NMJE, populate journal details for the NMJE, create a cover sheet for the NMJE, and attach supporting documentation to the NMJE.

In step 230, the preparer can electronically submit the NMJE to a user authorized to act as an Approver for review. The preparer can use a review module of a NMJE application to select from three types of entries: (1) batches not sent for approval; (2) batches pending approval; and (3) rejected batches. For each journal entry included in batches not sent for approval, the preparer can print or preview the associated cover sheet, submit the entry for approval, delete the entry, or revise the entry. For entries pending approval, the preparer can only preview the cover sheet created in PDF reader. For rejected entries, the user has the option of previewing the cover sheet, deleting the entry, or revising the entry.

In step 240, the approver can review the NMJE for compliance with a predetermined set of requirements. The approver can use an approval module of a NMJE application to review batches of entries submitted for approval. The Approver can review each entry along with its attached supporting documentation and either approve or reject the entry for submission to the general ledger. The Approver can indicate his approval by using an electronic signature of approval.

If the NMJE is rejected, the NMJE header, details, cover sheet, and supporting documentation can be reviewed and revised as needed in step 245 and then re-submitted electronically to the Approver to repeat the review process. If the NMJE is approved, it can be posted to a computer-implemented general ledger application in step 250. A Submission module of a NMJE application can be used to post approved NMJEs to the General Ledger. The preparer will be able to view a list of approved NMJEs on the Submission module. Once a NMJE is successfully sent for posting to general ledger, it will be removed from the list of approved NMJEs.

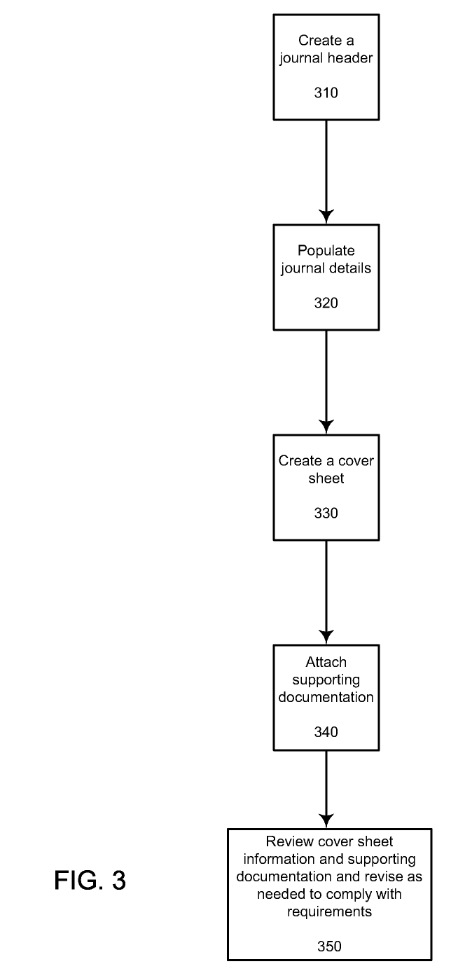

Referring to FIG. 3, an embodiment of a method for creating a NMJE using a NMJE application is shown. In step 310, the Preparer can create a Journal Header by selecting from three available options in a NMJE application: (1) Select or Correct recurring Entry; (2) Create a Non-Recurring Journal Entry; and (3) Correct a Non-Recurring Journal Entry.

In step 320, the Preparer can populate the journal detail information for the selected header type using the NMJE application. Transaction information can be typed in with the help of preloaded auto-complete lists. If existing entry information is available, the NMJE application can display transaction detail records, and the preparer can modify pre-loaded fields and records. Transaction details can also be uploaded from a user-prepared file. The preparer can used additional functionality in the NMJE application to populate the journal details in which an inter-company offset is automatically prepared by constructing a balancing company offset entry. The NMJE application can be used to insert a blank row in the journal details, remove selected rows from the journal details, and replicate the last NMJE record. The preparer can save changes to the NMJE journal details to preserve entered information for later use. The preparer can use the NMJE application to perform data entry validation, including company-branch-division verification, division and account confirmation, and debits and credits validation. The preparer can use the NMJE application to export the current NMJE from the NMJE application to save the current entry in Excel format, for example, for future use.

In step 330, the preparer can use the NMJE application to create a cover sheet for the NMJE. In the NMJE application, the preparer can be required to fill out a Purpose of Journal Entry field on the cover sheet to complete the NMJE. Additional information about the NMJE can be provided in additional data fields on the cover sheet.

In step 340, the preparer can attach supporting documentation for the non-machine entry to the NMJE. Each NMJE can be required to include supporting documentation before it can be posted to the general ledger. In the NMJE application, the preparer can complete data fields to describe all related documents and attach supporting files.

In step 350, the preparer can review the various components of the NMJE for compliance with a predetermined set of requirements associated with a NMJE. The preparer can revise the NMJE as need to comply with the requirements before submitting the NMJE for approval.

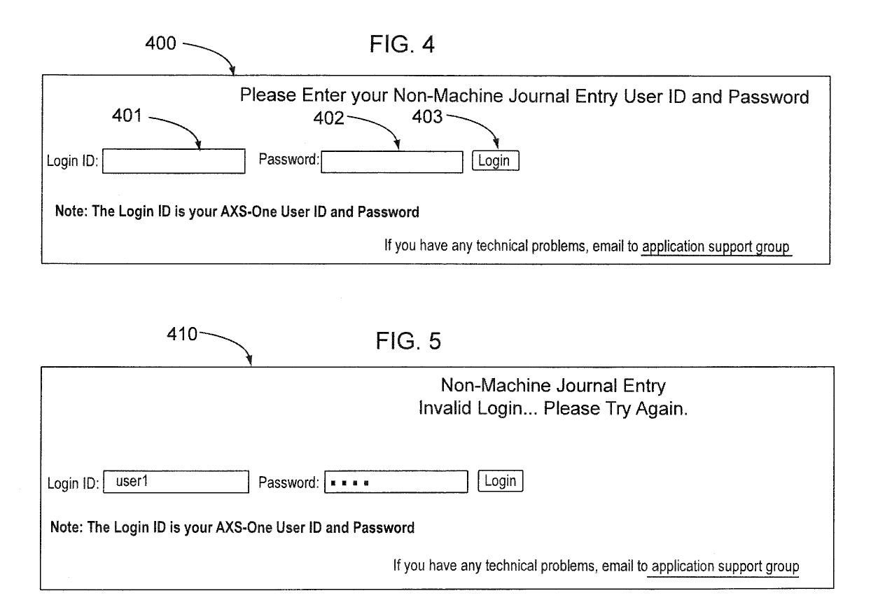

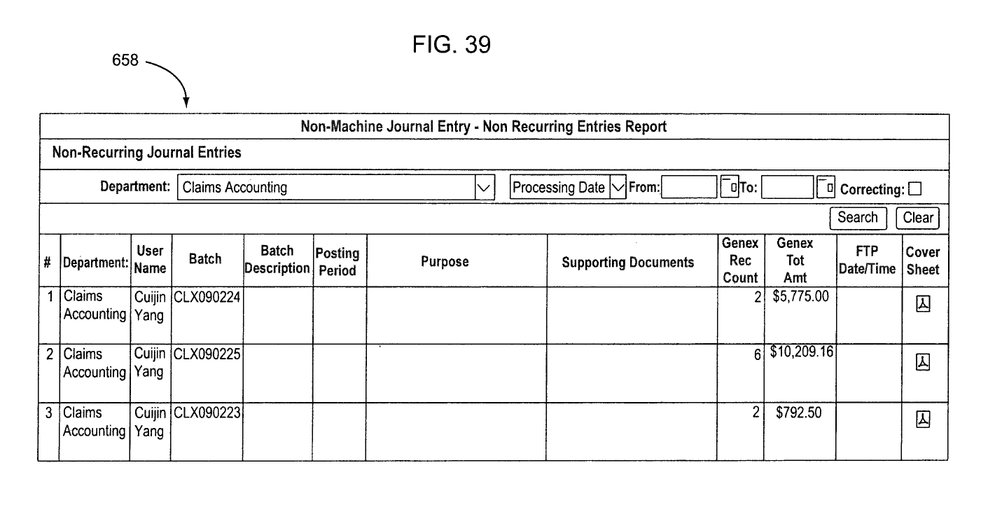

Referring to FIGS. 4-39, the NMJE application 155 can include a plurality of GUIs and electronic files to allow the user to navigate through the application to perform a computer-implemented method for posting a non-machine journal entry to a general ledger. A user can navigate through the modules of the NMJE application 155 using the GUIs to perform a computer-implemented method for posting a non-machine journal entry to a general ledger.

Referring to FIG. 4, an embodiment of a GUI for an initial login page 400 of a NMJE application is shown. By clicking on the URL link to the NMJE Web Platform, the user is directed to the Login Page 400. To log into the NMJE application, the user enters his Login ID 401 and a Password 402 and sends the information to the server by clicking a Login button 403. The login IDs for all users can be maintained in a table in a SQL Server database. The user Id and password can be sent to the general ledger server via FTP. Referring to FIG. 5, if an invalid username, an incorrect password, or an ID not created within the NMJE Web Platform is entered, an error message 410 will be sent. After the Login is verified, the processing is redirected to the NMJE application main page to the Home tab.

As part of the electronic approval and posting process for NMJEs, users can be required to authenticate their username and password against their general ledger username and password as they enter the system. All functions by the users are within a secure environment.

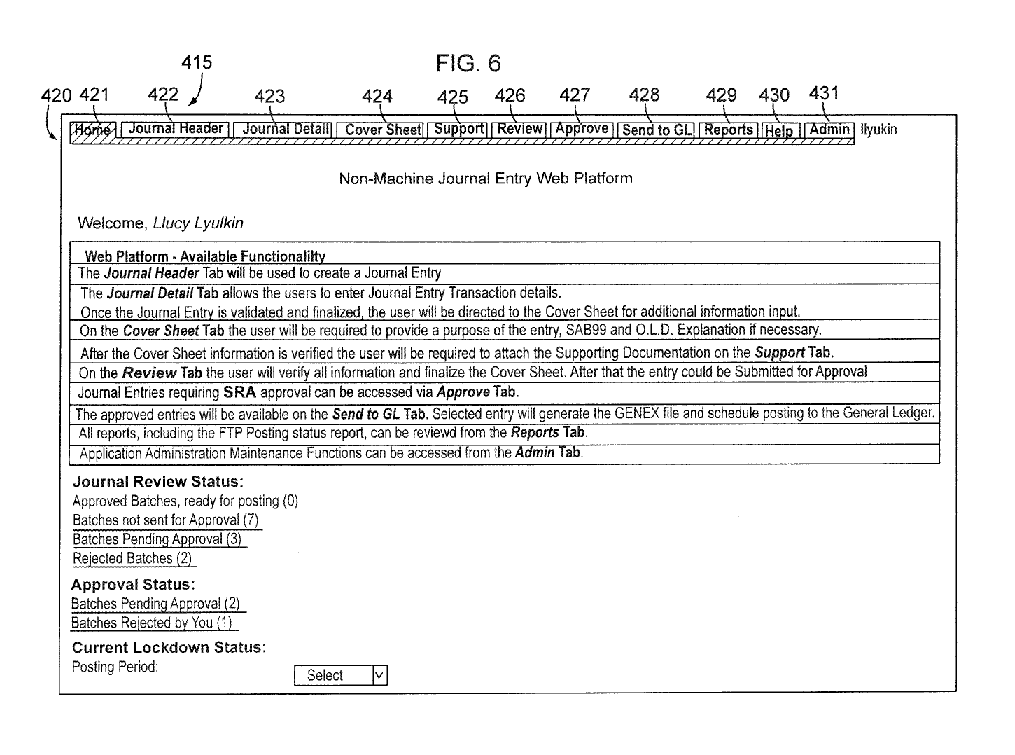

Referring to FIG. 6, after entering a valid Login ID on the Login Page 400, the user is directed to a NMJE web platform main page 415. The main page includes a system header 420 having a plurality of tabs 421, 422, 423, 424, 425, 426, 427, 428, 429, 430, 431 that a user can use to navigate through a computer-implemented method for posting a non-machine journal entry to a general ledger. The main page 420 includes a Home tab 421; a plurality of NMJE preparation tabs including a Journal Header tab 422, a Journal Detail tab 423, a Cover Sheet tab 424, a Support tab 425, and a Review tab 426; an Approve tab 427; a Send to General Ledger tab 428; a Reports tab 429; a Help tab 430; and an Administration tab 431.

The system header 420 for the NMJE Web Platform can be different depending upon the user's predetermined access level. A user can be a Preparer, an Approver, an Administrator, and/or a Reviewer. A user can have more than one access level status. Depending upon the access level status of the user, access to each one of the tabs of the system header can change.

In one embodiment, a Preparer has access to the Home tab 421, the Journal Header tab 422, the Journal Detail tab 423, the Cover Sheet tab 424, the Support tab 425, the Review tab 426, the Send to General Ledger tab 428, the Reports tab 429, and the Help tab 430. In one embodiment, an Approver has access to the Home tab 421, the Approve tab 427, the Reports tab 429, and the Help tab. 430 In one embodiment, an Administrator has access to the Home tab 421, the Reports tab 429, the Help tab 430, and the Administration tab 431. In one embodiment, a Reviewer has access to the Home tab 421, the Reports tab 429, and the Help tab 430.

In one embodiment, as a Preparer and an Approver, the user has access to all the tabs except the Administration tab 431. In one embodiment, as a Preparer only, the user will not have access to the Approve tab 427 or the Administration tab 431. In one embodiment, as an Approver only, the user will not have access to the journal entry preparation tabs 422, 423, 424, 425, 426; the send entries to the general ledger tab 428; or the Administration tab 431. Users that are not Preparers or Approvers can be restricted to access to the reporting features.

In other embodiments, the access of each access level status can be different. In yet other embodiments, different access levels can be used.

Referring to FIG. 6, the Home tab 421 is shown. The Home tab 421 is a tool to direct the user through the NMJE Web Platform by describing, at a high level, the purpose of each of the tabs of the system header that are available to the user. The Home tab will provide the user with a preview of their entry status. When there are entries available in these areas, hyperlinks are present that are “clickable” to launch the particular tab that correlates with the function displayed in the hyperlink. Users that do not have any entries available in a functional area (Journal Review Status and Approval Status) will not see that functional area listed at all.

The Home tab 421 also includes a Current Lockdown Status display. The Current Lockdown Status display of the Home tab 421 is a reference tool for the user to help identify which accounting periods are currently locked. The NMJE Web Platform can include a lockdown functionality to allow the company to selectively lockdown a posting period, lockdown a journal, lockdown an accounting department, and/or lockdown a business unit, for example, to prevent further posting to the general ledger in connection with the area that has been locked down. The lockdown functionality can help manage the quarter close and control posting authority in an effort to maintain the integrity of the books and records of the company. The user can view the current lockdown options from the Home tab 421 and select a posting period from the dropdown to see if there are any active lockdowns in place. The NMJE Web Platform can include a lockdown functionality that locks down other areas of the company in yet other embodiments.

The system regulates timing and permissions of posting entries to the general ledger by means of the LockDown mechanism. To help perform an efficient quarter close and control posting authority, the LockDown functionality is provided. The following rules are enforced by the LockDown mechanism: Lockdown by Posting Period; Lockdown by Journal; Lockdown by Department; Lockdown by Company. Each Lockdown rule can have an exception.

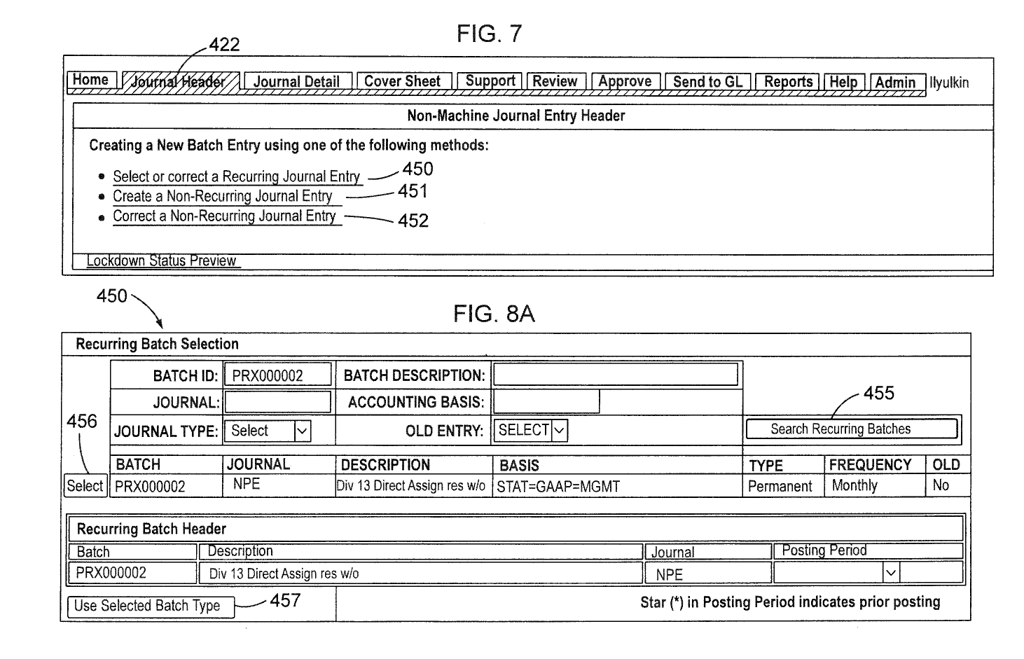

Referring to FIG. 7, the Journal Header tab 422 can be used to create a NMJE. The Journal Header tab 422 includes a plurality of hyperlinks that when selected each launches a window for creating a particular head for the NMJE. The following options are available from the Journal Header screen for a NMJE: (1) Select or Correct a Recurring Journal Entry 450; (2) Create a Non-Recurring Journal Entry 451; or (3) Correct a Non-Recurring Journal Entry 452. A Lockdown Status Preview link is also available in the Journal Header tab.

A list of recurring entries can be prepared for use with the NMJE web platform. This list of recurring entries can be reviewed and approved by management as being deemed to be required each accounting period (monthly or quarterly). A non-recurring entry is usually one-time in nature.

A correcting entry can be a revised estimate or change to the dollar amount; a change to a ledger account; or a change to a company, branch, department, division, section, PUC or company-state-major class code, for example. A correcting entry can be recurring or non-recurring. A correction to a recurring entry is used to correct a recurring entry previously recorded in the same accounting period. Correcting an entry that was previously recorded in a prior accounting period can be viewed as a SAB99 situation. Such a change is processed as a correction to a non-recurring journal entry (option three).

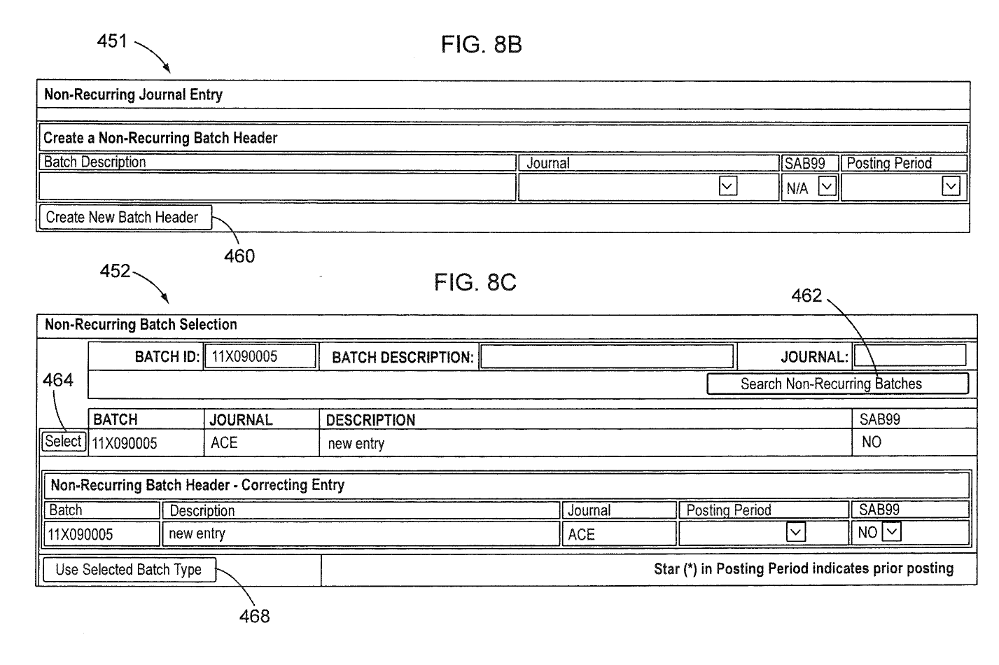

Referring to FIG. 8A, by selecting the Select or Correct a Recurring Journal Entry link 450, a Preparer can enter a recurring entry or correct a recurring entry. The Preparer can search for an existing recurring entry by batch information, journal information, accounting basis, and/or or by department. When the Preparer finds and selects an entry from the list, all header information for this entry is displayed along with the posting period that the Preparer is required to select. All prior postings are noted with the asterisk (*). If the Preparer selected an entry with the asterisk, the Journal Entry will be noted as a correcting entry.

To enter or correct a recurring entry, the Preparer clicks the Select or Correct a Recurring Journal Entry link 450. The Preparer enters data in any of the fields and then clicks a Search Recurring Batches button 455. A list of entries matching the search criteria appears below the Search Recurring Batches button. In the illustrated example only one entry is displayed as a search result. The Preparer can find the entry from the search results that is desired to be posted and click a Select button 456 displayed to the left of the entry to display the selected entry below the search results list.

The Preparer completes the data fields displayed in the Recurring Batch Header section by entering a description and using a drop-down feature to select the appropriate posting period. If there is no asterisk next to the date in the drop-down list, it is an indication that there is no entry for the selected time period for this recurring entry. Using this time period will indicate an initial entry. If there is an asterisk next to the date in the drop-down list, it is an indication that the entry has already been used for that time period. Using the time period again will indicate a correcting entry. If the information on the screen is correct and this is the entry the Preparer desires to post, the Preparer clicks the Use Selected Batch Type button 457.

The Batch number is nine characters long and is built by the application. The Journal Code is three characters. The application provides a list of journals to select from. For the posting period, the application provides a list of Posting Dates to select from. For Monthly Frequency, the Posting Date is set to the last day of month. For Quarterly Frequency, the Posting Date is set to the last day of quarter.

Referring to FIG. 8B, to enter a non-recurring entry, the Preparer selects the Create a Non-Recurring Journal Entry link 451. The Preparer enters a batch description in a Batch Description field. The description can be limited to a predetermined character length, such as thirty characters, for example. Preferably, the batch description uses descriptive words to make the description meaningful to other users of the NMJE application and that avoids the use of information found in other data fields such as time frame. The Preparer select the journal using the drop-down box. The Preparer selects Yes or No for the SAB99 indicator using the drop-down. Yes can be selected to indicate a SAB99 situation wherein the correction is to an entry that was previously recorded in a prior accounting period. The Preparer selects the posting period using the drop-down. If the information on the screen is correct and this is the entry the Preparer desires to post, the Preparer clicks the Create New Batch Header button 460.

Referring to FIG. 8C, to enter a correction to a non-recurring entry, the Preparer selects the Correct a Non-Recurring Journal Entry link 452. The Preparer enters data in any of the fields and then clicks a Search Non-Recurring Batches button 462. A list of entries matching the search criteria appears below the Search Non-Recurring Batches button. In the illustrated example only one entry is displayed as a search result. The Preparer can find the entry from the search results that is desired to be posted and click a Select button 464 displayed to the left of the entry to display the selected entry below the search results list.

The Preparer uses a drop-down feature to select the appropriate posting period and to indicate whether the correction is a SAB99 situation. If the information on the screen is correct and this is the entry the Preparer desires to post, the Preparer clicks the Use Selected Batch Type button 468.

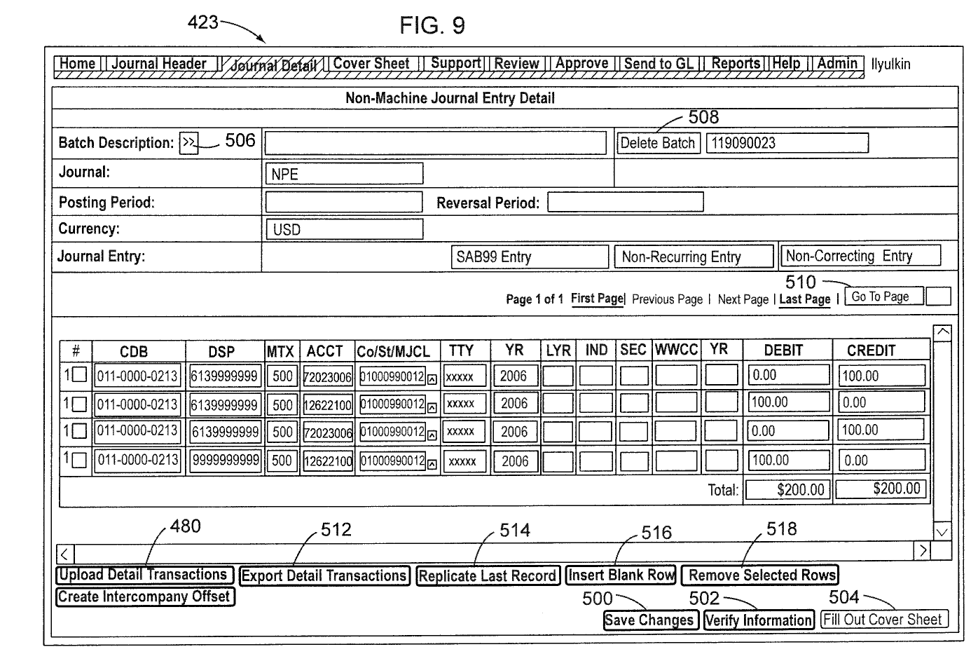

Referring to FIG. 9, after the Preparer fills out the Journal Header information and selects the Use Selected Batch Type or Create New Batch Header button as appropriate, the Preparer is redirected to the Journal Detail tab 423. The Journal Detail tab 423 allows the Preparer to enter NMJE transaction details. Once the NMJE is validated and finalized, the Preparer will be directed to the Cover Sheet tab 424 for additional information input.

The following fields can be pre-populated in the Journal Detail tab 423 such that they are not editable: Batch Description, Journal, Posting Period, Reversal Period, Batch Number, and Journal Entry descriptive fields. The Reversal Period will always be the first day of the next accounting period. If the NMJE is not using a reversing journal, the Reversal Period field will be blank. If the NMJE is using a reversing journal, the Reversal Period field will be blank until the NMJE is saved. Once the NMJE is saved, the Reversal Period field will be populated with the reversal date.

For Recurring entries, the full batch number will be populated in the Batch Number field. For Non-Recurring entries, only the first five characters will be populated in the Batch Number field. The Journal Entry descriptive fields include a first field to indicate whether the NMJE is a SAB99 or Non SAB99 event, a second field to indicate whether the NMJE is recurring or non-recurring, and a third field to indicate whether the NMJE is correcting or non-correcting.

The fields of a Journal Entry Coding Block include a CBD field, a DSP field, a MTX field, an ACCT field, a Co/St/MJCL field, a TTY field, a first YR field, a LYR field, an IND field, a SEC field, A WWCC field, a second YR field, a DEBIT field, and a CREDIT field.

The CBD field is a code for the company C, branch B, and division D to which the NMJE relates. The CBD field code can be in a twelve-character format broken up into three four-character portions separated by dashes (xxxx-xxxx-xxxx). The NMJE application can present a pre-populating list of valid CBD codes that appear as the Preparer types characters into the CBD field.

The DSP field is a code for the division D, section S, and profit unit code (PUC) P to which the NMJE relates. The DSP field code can be in a ten-character format broken up into two three-character portions separated by a dash for the division D and the section S and a four character portion for the PUC offset from the section S portion by a dash (xxx-xxx-xxxx). The NMJE application can present a pre-populating list of valid DSP codes that appear as the Preparer types characters into the DSP field.

The MTX field is a matrix code that can be in three character format. The matrix code relates to a particular market segment. The NMJE application can present a pre-populating list of valid MTX codes that appear as the Preparer types characters into the MTX field.

The ACCT field is a code for the particular general ledger account to which the NMJE relates. The ACCT field code can be in eight-character format. The NMJE application can present a pre-populating list of valid ACCT codes that appear as the Preparer types characters into the ACCT field.

The Co/St/MJCL field is a code for the company Co, tax state St, and major class code MJCL to which the NMJE relates. The Co/St/MJCL field code can be in eleven-character format with the first four characters relating to the company Co portion, the next three characters relating to the tax state St portion, and the final four characters relating to the major class code MJCL (xxxx-xxx-xxxx). The preparer can type in the four characters of the company code and select the blue button to the right of the Co/St/MJCL field to see a selection of valid Co/St/MJCL field codes for that company displayed in a new window.

The DEBIT and CREDIT fields relate to conventional accounting debit and credit information and accept numeric characters corresponding to the currency used for the NMJE (e.g. $x.xx). The DEBIT and CREDIT fields cannot both be populated for a single NMJE, cannot both be zero, and cannot be a negative number.

The reinsurance fields include the TTY, the first YR, the LYR, the IND, the SEC, the WWCC, and the second YR fields. The TTY field is a code for the treaty number which relates to the NMJE. The TTY field code can be in six-character format. The first YR field is a code for the underwriting year for the treaty which is in four-character format. The LYR field is a code for the layer which is in two-character format. The IND field is a code for the indicator which is in one-character format. The SEC field is a code for the section which is in two-character format. The WWCC field is a code corresponding to the world-wide company code for reinsurers which is in five-character format. The second YR field is a code for the underwriting year which is in two-character format.

The first time a Preparer enters a recurring journal entry, the lines of the Journal Entry will be blank. The second time and subsequent times a Preparer posts a recurring journal entry, the lines of the entry will be populated with the most recent posting. The Journal Entry lines of a non-recurring NMJE are always blank. If previously posted detail transactions are present for the selected type of entry, the details are populated on the screen.

Detail transactions can be typed in, copied from one record to another, or uploaded from a previously prepared (.csv or .txt) file. The CBD, DSP, MTX, and ACCT field code information is available for selection via pre-populated hidden drop-down lists that become visible as soon as the Preparer starts typing. As the Preparer enters the values, the NMJE application displays data matching values already entered for selection as an auto-complete feature.

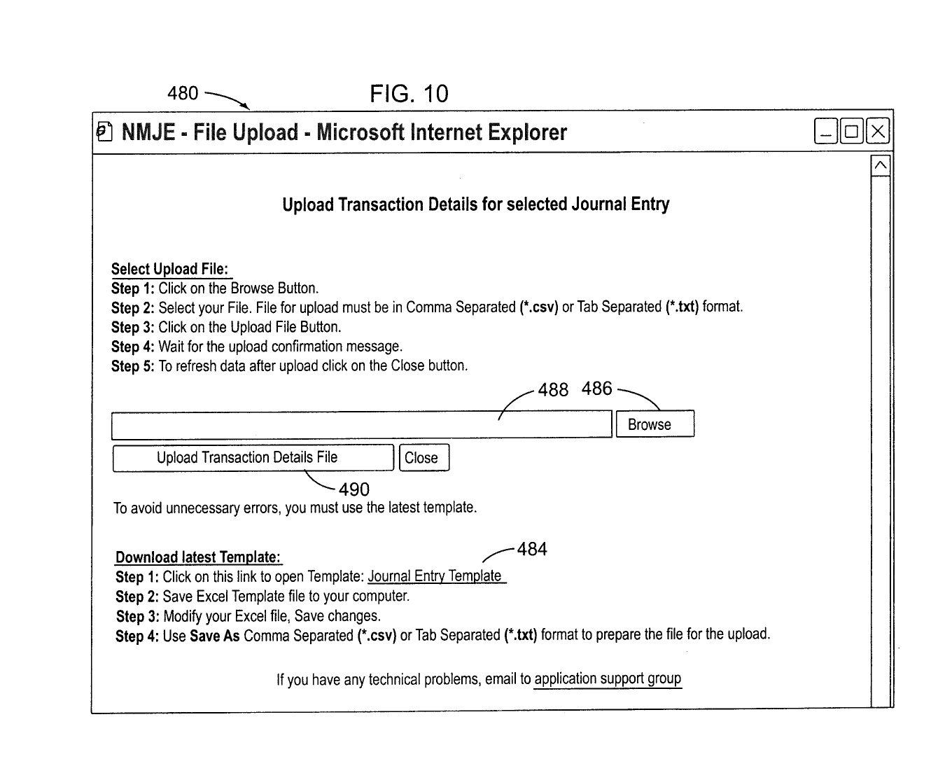

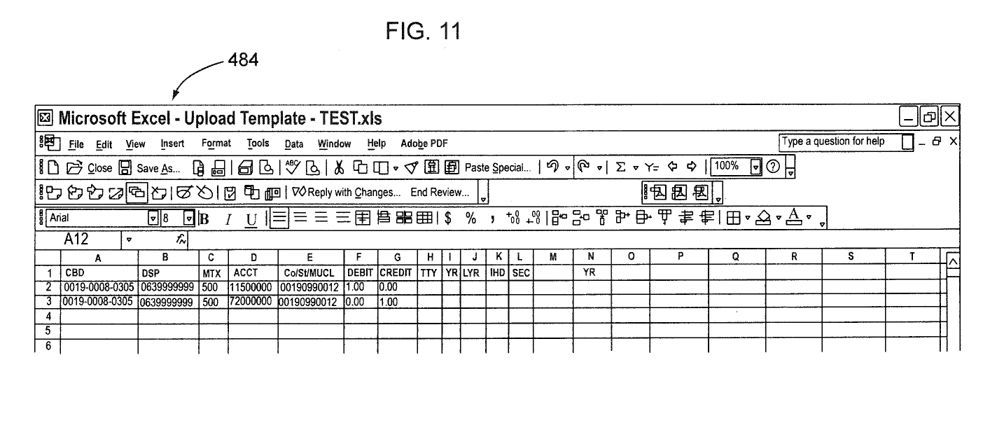

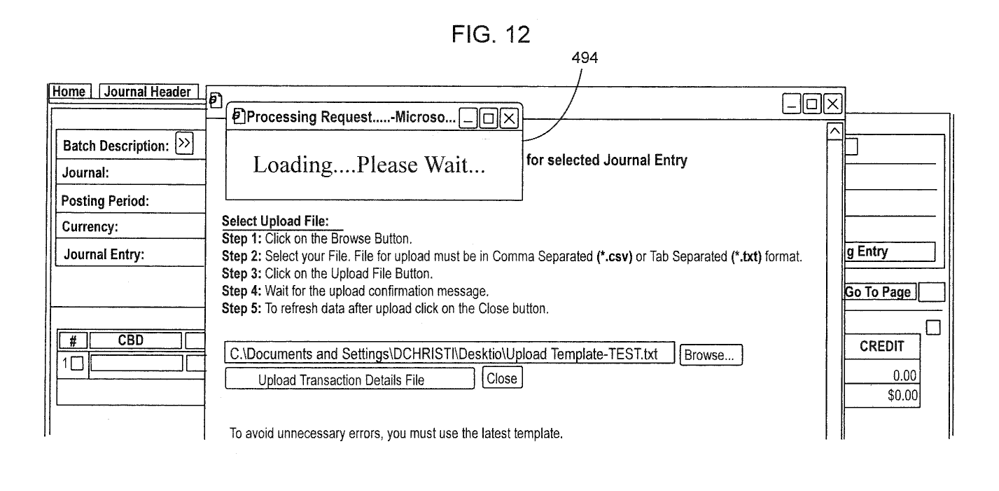

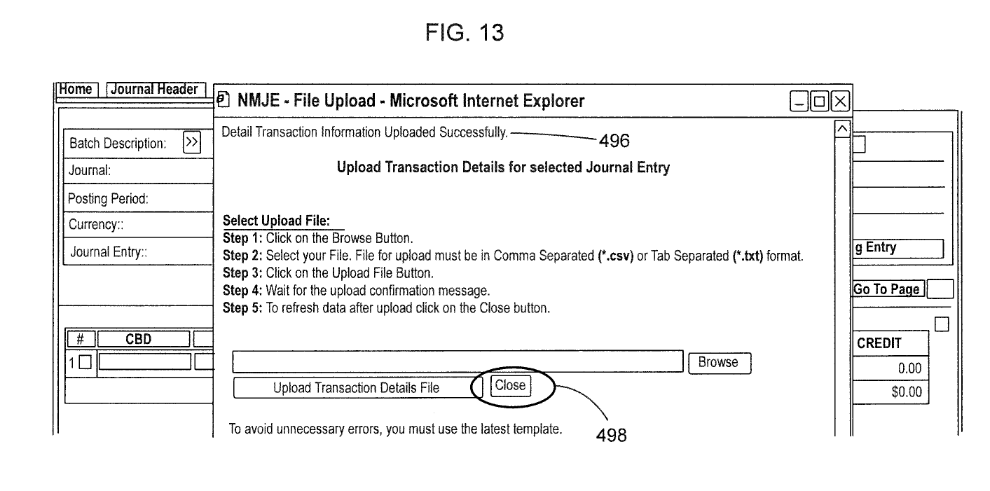

By selecting an Upload Detail Transactions button 480, the Preparer launches a pop-up window which includes the functionality of an upload option to load the Journal Entry fields of the Journal Detail tab 423 with data in a previously-saved CSV or TXT format Excel file. The NMJE File Upload window 480 (FIG. 10) includes a Journal Entry Template link 484 for launching a template which can be used to enter NMJE data (FIG. 11). The template can be in the form of a Microsoft Excel file formatted to correspond to the fields in the Journal Entry fields of the Journal Detail tab. The Preparer can follow the steps listed in the NMJE-File Upload window to enter NMJE data into the Excel template. Referring to FIG. 10, after doing so, the Preparer can select a Browse button 486 to navigate to the location where the file is saved. The file can be selected to populate the file path field 488 in the NMJE-File Upload window. The Preparer can select the Upload Transaction Details File button 490 to launch a popup box 494 (FIG. 12) that informs the Preparer that the selected file is loading into the Journal Detail tab. Referring to FIG. 13, a successful message 496 will populate if the Preparer has the uploaded file in the correct format, and the Preparer can close this pop-up window by selecting a Close button 498. A failed message appears if the load steps have not been followed properly or if the data in the uploaded file is incompatible. The Journal Detail tab will populate with the uploaded entry in a few seconds. Any detail previously populated on the Journal Detail tab can be overridden by a new uploaded file. All the detail information will be replaced by the uploaded file details.

In some embodiments, at least one validation rule can be built into the NMJE Web Platform to ensure that the data being sent to the general ledger is accurate. The NMJE application can perform various data validation features. The batch journal can be validated against the journal type and the required reversal date using SQL Tables. All companies in a batch can be validated against the batch journal using an SQL table. The currency selected can be validated for the specific company entered using an SQL table. The CBD, DSP, MTX, ACCT, Co/St/MJCL field can be analyzed to confirm each is valid individually. The CBD and MJCL data can be validated by comparing the first four characters of each to the other. The first four characters of CBD and MJCL should be the same. The division and section portion of the DSP value (first 6 characters) can be validated using an SQL Table. The company/branch/department portions of the CBD value can be validated against the division portion of DSP (first 3 characters) using a SQL Table.

A debit/credit validation can be performed by verifying that the summary debits are equal to the summary credits. The summary of debits and credits can not be equal to zero. Each record can be verified to have a debit or credit amount entered. The total debits and credits should balance for each company within a batch.

Debits and credits of the journal entry can be analyzed to determine they balance in total. Debits and credits of the journal entry must balance by company. Both the Debit and Credit can not be zero for a given line. The sum of the Debit and Credit can not be zero for a given line. Both the Debit and Credit can not be entered on a given line. Each Debit or Credit amount for a given line must be a positive number. Net debit or credit in a change in reserve account must be offset with the corresponding reserve account and balance by company.

In some embodiments, multiple currencies are not allowed in a single batch. Each batch can be analyzed to determine they contain companies whose currencies are either entirely USD or CAD.

A treaty validation (TTY, YR, LYR, IND, and SEC) can be performed by verifying that all fields are blank, all fields are populated, or only TTY and YR are populated. Alpha values are invalid for the treaty fields (except for IND). For the IND field, valid combinations include an alpha value, blank, C (Canada), D (Domestic), or F (Foreign).

For the WWCC and YR fields, a validation function can be performed by verifying that a valid combination is used. Valid combinations include both fields blank or both fields fully populated. Alpha values are invalid for the WWCC and YR fields. Format validations for all lines of every journal entry can be performed.

Referring to FIG. 9, if the journal entry is as intended, the Prepare can select a Save Changes button 500 at the bottom right of the Journal Detail page 423 and then select a Verify Information button 502 to initiate the validation functionality. A green successful message will appear at the top of the Journal Detail page if there are no validation errors. A pop up can appear on the Preparer's display screen if the NMJE data is incomplete. The pop-up window can include a message describing the nature of the problem to allow the Preparer to correct the omission.

Validation errors can be displayed as a pop up message box on the Preparer's screen or as a red message at the top of the Journal Detail page 423 with a View Error Report link to an error report. The Preparer can click on the View Error Report link to view the validation errors. The Error Report can include information to allow the Preparer to correct the validation problems. For example, the Error Report can direct the Preparer to the page and record number where the error exists.

The Preparer can repeat the save and validation process until he receives a green successful message at the top of the Journal Detail page 423. Upon receiving a green successful message, the Prepare can select a Fill Out Cover Sheet button 504 which can become active upon the successful completion of the Verify Information function to be directed to the Cover Sheet tab.

An Arrow button 506 to the right of the Batch Description text the for the Batch Description field can be used to launch a pop-up window to display a Work In Progress window that lists NMJEs that are in process to allow a Preparer to interrupt his work and return at a later time to resume work on a particular NMJE. The pop-up window can include a listing of in process NMJEs. One of the in-process NMJEs can be selected by clicking on a circle to the left of the NMJE. A dot can be populated within the selected circle to indicate to the Preparer that the NMJE was chosen. A Select button can then be clicked on to load the chosen NMJE in the Journal Detail tab.

The Journal Detail page 423 includes a Delete Batch button 508 to allow an in process entry to be deleted. To help avoid inadvertent deletion, when the Delete Batch button 508 is selected, a message box can appear asking the Preparer to confirm he wishes to continue with the delete task.

The Journal Detail page 423 includes First Page, Previous Page, Next Page and Last Page links. These links allow the Preparer to navigate through the lines of the NMJE. A Go To Page button 510 allows the Preparer to navigate through the lines of the NMJE by selecting a specific page number. The Preparer can enter a page number in the box to the right of the Go To Page button 51 and then select the button 510 to move to the entered page number.

An Export Detail Transactions button 512 allows the Preparer to download the NMJE into a .CSV or .XLS file format. A Replicate Last Record button 514 allows the Preparer to add a new row to the NMJE using the same data as the last row. An Insert Blank Row button 516 allows the Preparer to insert a blank row in the journal entry. A Remove Selected Rows button 518 allows the Preparer to delete selected rows. The Preparer can place a check mark in each box to the left of the rows the Preparer wants to delete, and then click on the Remove Selected Rows button to delete the checked rows. A message box will appear with a warning to confirm that the Preparer wishes to delete the chosen rows. By clicking an OK button, the Prepare continues with the deletion of the chosen rows. A Cancel button can be selected to abort the deletion.

The Save Changes button 500 allows the Preparer to save all changes made to the journal entry. The Verify Information button 502 allows the Preparer to launch the validation process. The detail journal entry must be verified before the Preparer can proceed to the cover sheet. Each time a change is made to the detail, the Preparer can be required re-verify the information. The Fill Out Cover Sheet button 504 directs the user to the Cover Sheet tab 424 and can be configured such that it is active only after successfully completing the verification function of the application triggered by selecting the Verify Information button 502.

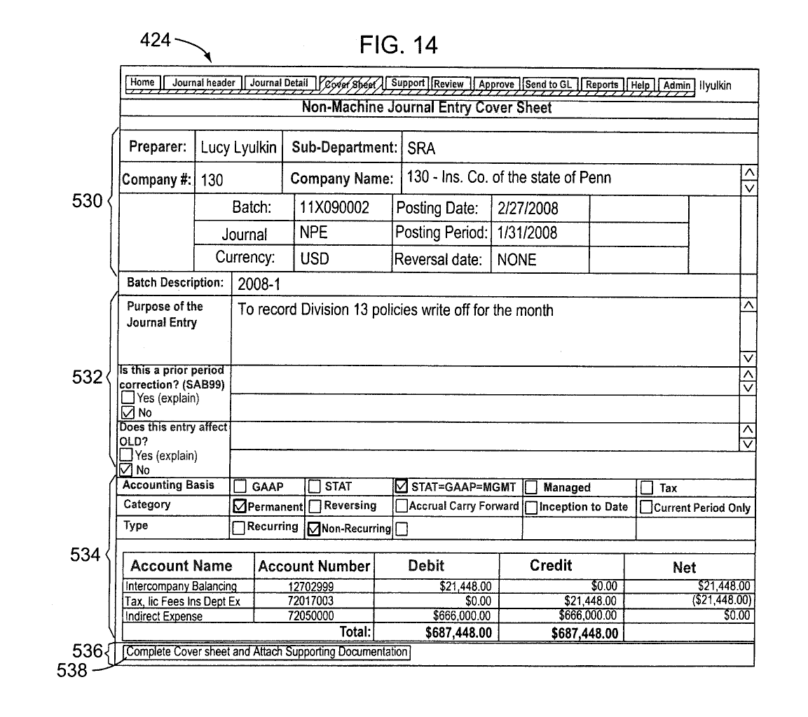

Referring to FIG. 14, the Cover Sheet tab 424 is shown. In this embodiment, the Cover Sheet tab 424 includes a Locked component 530, a User-Input component 532, a Reminder component 534, and a User-Action component 536.

The Locked component 530 is pre-populated when the Preparer arrives at the Cover Sheet tab 424 based upon data previously entered in the other tabs. This data cannot be modified at this point. The Locked component 532 includes the following fields: Preparer, Sub-Department, Company Number, Company Name, Batch, Journal, Currency, Posting Date, Posting Period, Reversal Date, and Batch Description.

The User-Input component 532 includes fields that may require data entry by the Preparer. The User-Input component includes the following fields: a Purpose of the Journal Entry field, a SAB99 field, and an Outstanding Loss Drafts account (OLD) field.

The Preparer enters information in the Purpose of the Journal Entry field for new non-recurring batches. For recurring entries, the purpose will be pre-populated.

If the NMJE is a SAB99 situation, then the Preparer checks the Yes box and provides a SAB99 explanation. If the NMJE is not a SAB99 situation, the Preparer checks the No box and no explanation is given.

In this embodiment, OLD is a particular account on the general ledger that is monitored closely. In other embodiments, a different account can be isolated for particular scrutiny. If the NMJE affects OLD, then the Preparer checks the Yes box and provides an explanation. If the NMJE does not affect OLD, the Preparer checks the No box and no explanation is given.

The Reminder component 534 includes three rows of data for the Preparer to use as a reminder to what the NMJE contains. These reminder rows can be used to double check that the NMJE is going to affect the general ledger as expected.

The Debits and Credits by account are shown at the bottom of the page. The Net of Debits/Credits by account is also shown. The Net of Debits/Credits column shows the total overall impact to a specific account. This Net of Debits/Credits column can appear in all places where Debits/Credits information by account is shown, including on the PDF Cover Sheet and on the Review tab 426.

The Prepare can use this information to ensure that the NMJE is correct. To change the journal detail at this point, the Prepare can return to the Journal Detail tab 423 to make changes.

The User-Action component 536 includes a Complete Cover Sheet and Attach Supporting Documentation button 538. When the Preparer has reviewed the cover sheet and is satisfied with the NMJE, he can select the Complete Cover Sheet and Attach Supporting Documentation button 538 to navigate to the Support tab 425.

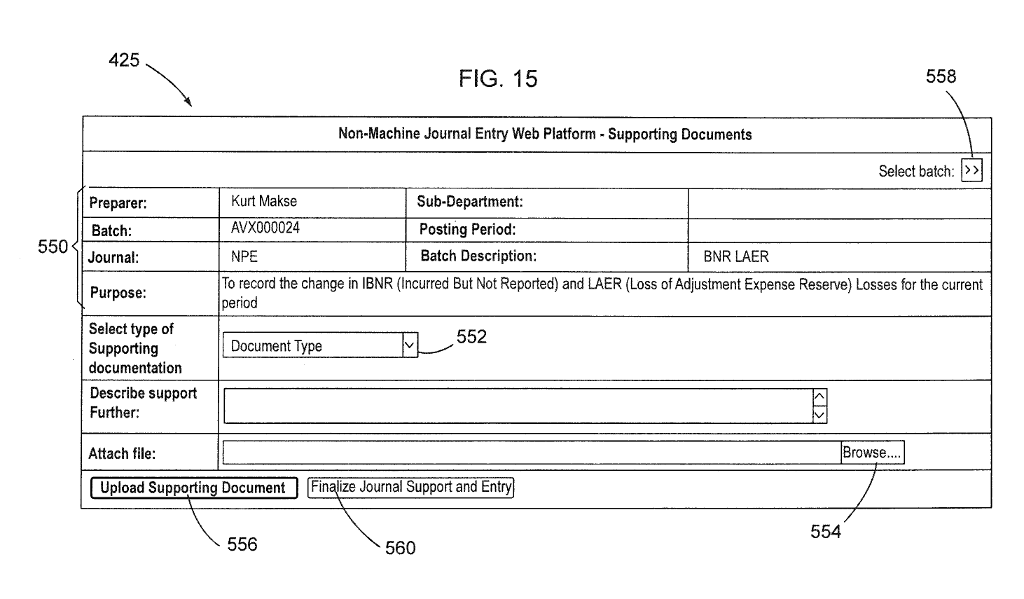

Referring to FIG. 15, on the Support page 425, the preparer describes and attaches the supporting documentation for the NMJE. The NMJE application can be used to require the Preparer to document support for the NMJE and consolidate this information by attaching the support to the NMJE. A Locked component 550 includes the following fields: Preparer, Batch, Journal, Sub-Department, Posting Period, Batch Description, and Purpose. The Locked component 550 can be pre-populated with data previously entered by the Preparer. The Preparer can enter data in a Type field and a Description field.

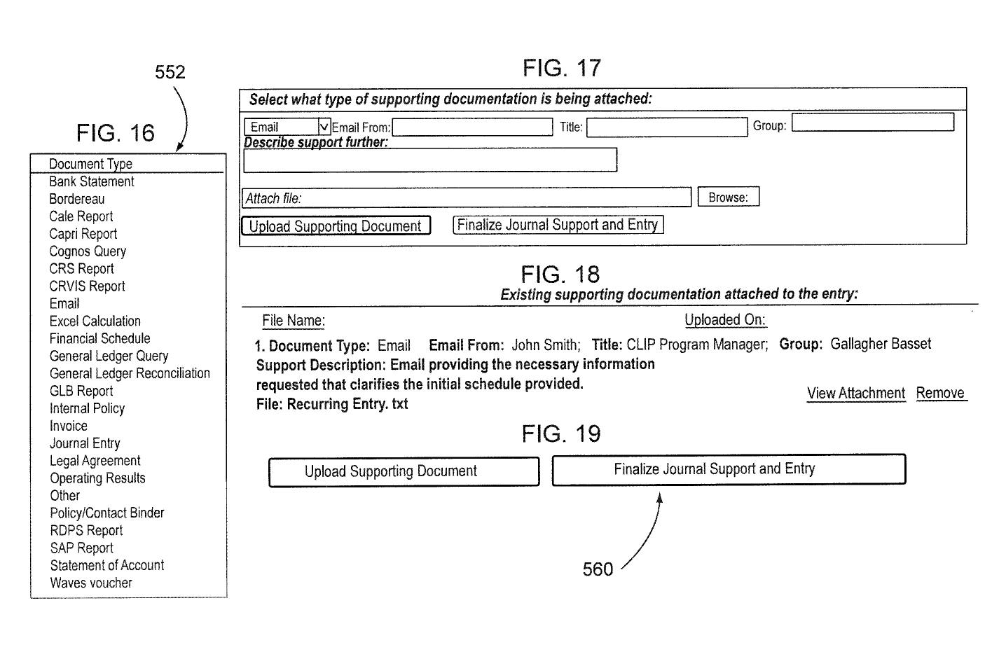

The Type field can include a drop-down menu 552 (FIG. 16) having a pre-set list of types of supporting documents with pre-set field requirements for each. Additional fields can be added over time as needed. For example, a user that is attaching an email can document who sent the email and the sender's position/title and group (FIG. 17).

Referring to FIG. 15, in the Description field, the Preparer can explain why this piece of support is relevant to the entry. The additional information about the support can allow for a query to be run and a report to be generated of the supporting documentation. This ability can reduce the number of questions that auditors, regulators and other interested parties have when reviewing the NMJEs.

After describing the particular supporting document, the Preparer can upload the file to the system. Files greater than a predetermined size, 5 MBs for example, can be zipped so as to allow for faster upload. The Preparer can select the file by clicking a Browse button 554, navigating through the directory in a pop-up window to find the desired file, and selecting the desired file. The path of the selected file is populated in the Attach File field. The Preparer can press an Upload Supporting Document button 556 to upload the file to the NMJE application. As the file uploads, a pop-up message on the Preparer's screen can appear to indicate that the file is currently uploading.

Once the upload has completed, the file will appear at the bottom of the screen with a summary of the information that the Preparer provided (FIG. 18). The user can view the attachment or remove the supporting document by selecting the appropriate link at the bottom of the Support page.

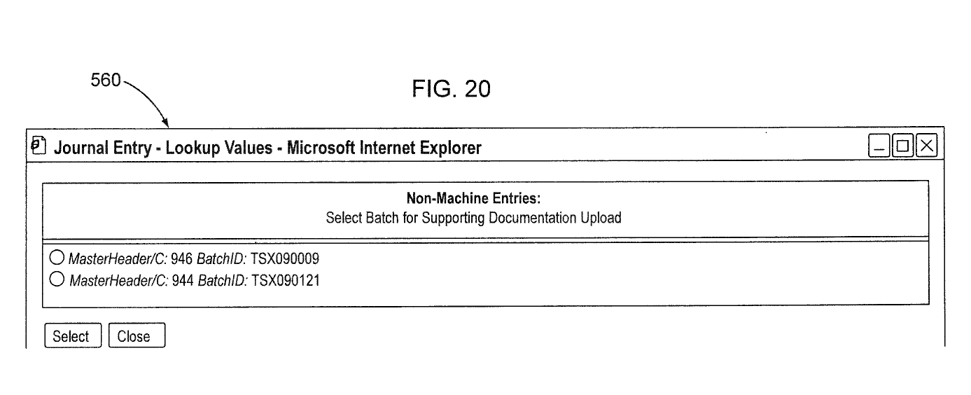

Once the Preparer has uploaded a supporting document, the Preparer then has the option to either upload an additional supporting document or to finalize the journal entry support and do a final review. The Preparer can select the Upload Supporting Document button 556 to attach additional supporting documentation. After each document is uploaded, it is immediately saved by the system, so if the Preparer chooses to close out, he can still retrieve the batch later on by clicking a double arrow 558 next to Select Batch (FIG. 15). Clicking on the double arrow 558 opens a pop-up window 560 that has the functionality to allow the Preparer to select from batches which have not yet been sent for approval (FIG. 20).

Referring to FIG. 15, a Finalize Journal Support and Entry button 560 becomes active only after at least one supporting document has been attached. Referring to FIG. 19, the Preparer can select the Finalize Journal Support and Entry button 560 to be taken to the Review tab 426.

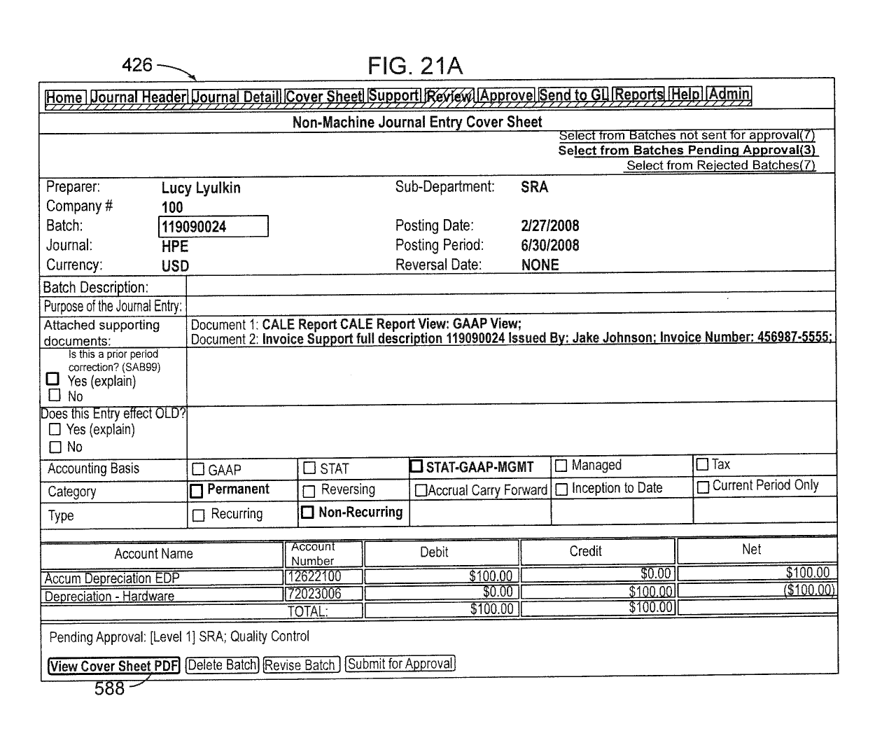

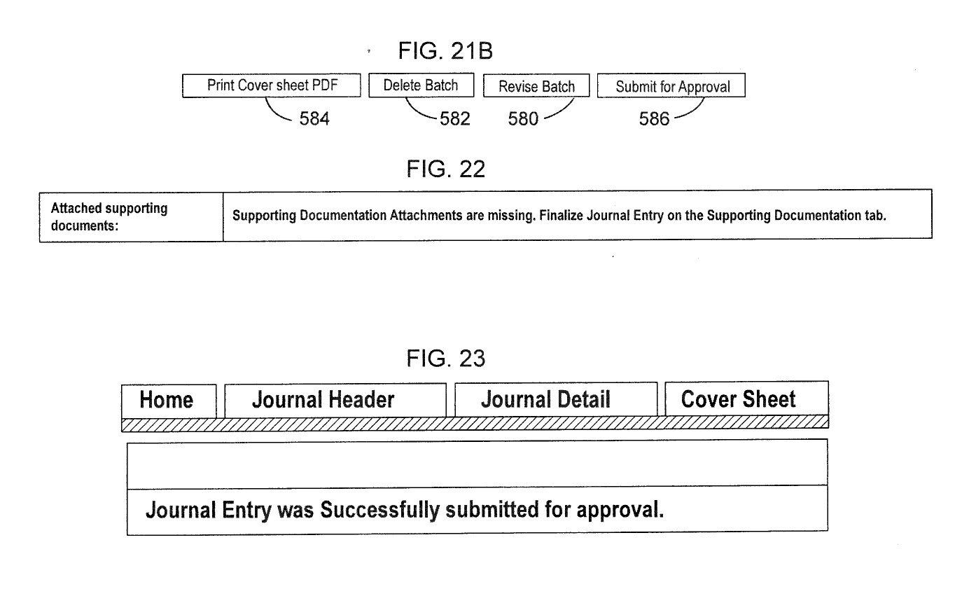

Referring to FIG. 21A, after the Finalize Journal Support and Entry button in the Support tab has been selected, the Preparer is directed to the Review tab 426. On the Review tab, the user can verify all information relating to the NMJE. The Review tab allows the user to select NMJEs from three types of entries: (1) batches not sent for approval; (2) batches pending approval; and (3) rejected batches.

Batches not sent for approval are NMJEs that have had the cover sheets finalized but have not been sent for approval. This category includes entries where the supporting documentation is still being worked on or where it has been completed but not sent off for the approval process. Batches can be retrieved on the Review tab 426 while the supporting documentation is being worked on so as to allow the users to be able to review both the support and the detail of the entry.

Batches pending approval are entries that have been sent off for approval by the Preparer but have not received all the necessary approval nor have they been rejected. The Preparer at this point can see what approvals have been obtained and which are still outstanding.

Rejected batches are entries that have been rejected by an approver. When this happens the Preparer can see who rejected the entry and why the entry was rejected. The Preparer can have the option to either revise the batch or delete the batch. In some embodiments, the Preparer cannot resubmit a rejected NMJE for approval without making changes to it. A rejected entry can only be revised or deleted by the Preparer.

The following functions are available on the Review page: (1) Delete Batch to completely remove a finalized batch from the system; (2) Revise Batch to remove a finalized batch with the intention of making more changes to the entry; (3) Print/Preview PDF Cover Sheet; and (4) Submit for Approval (if entry has not been submitted yet).

Referring to FIG. 21B, when a Revise Batch button 580 is selected, the Preparer is prompted for a confirmation to revise the batch. Upon confirming, the Preparer is directed to the Journal Detail tab 423 where the desired changes to the NMJE can be made. After making the revisions, the Preparer must re-verify the information and fill out the cover sheet again.

When a Delete Batch button 582 is selected, the Preparer is prompted for a confirmation to delete the batch. Once the Preparer confirms deletion, the NMJE application removes the entry.

When the Preparer selects a Print Cover Sheet PDF button 584, a copy of the Cover Sheet appears as a pdf file. The Cover sheet pdf can be printed and saved to a desired location.

Once a Submit for Approval button 586 is selected, the NMJE is submitted for review to a designated Approver and the NMJE is locked such that the Preparer cannot modify the entry in any way. Should the Preparer desire to change the entry after it is submitted for approval, the designated Approver must reject it to allow the Preparer to modify it. In that way, the NMJE application helps avoid confusion and waste by preserving a chain of review to prevent subsequent version of the single NMJE from proliferating through the system.

If an entry is selected on the Review tab 426 that has not had its supporting documentation finalized, the Print Cover Sheet PDF and Submit for Approval buttons 584, 586 will not be operable. Additionally, a message will appear in the Supporting Documents area indicating no support has been attached (FIG. 22). The user can either go to the Support tab 425 and attach supporting documents or revise or delete the batch. Once supporting documentation has been finalized, the user will be able to view the document by clicking the document link or read the detail of each field submitted for the document.

Referring to FIG. 23, after selecting the Submit for Approval button, a message can be displayed in the Review tab that the Journal Entry was successfully submitted for approval. The message confirms to the Preparer that the first level of approval now has the entry available for review. The bottom of the Review page will also be updated and will indicate which department(s) must now approve the NMJE. Referring to FIG. 21A, after selecting the Submit for Approval button 586, the Print Cover Sheet PDF button refreshes as a View Cover Sheet PDF button 588 to allow the user to view the current approval status of the NMJE as indicated by a watermark on the cover sheet. As each level of approval is obtained, the PDF cover sheet will update with the approver's name and department and the Pending Approval department list will shrink correspondingly.

If an entry is rejected by an Approver, the NMJE can appear back on the Review tab 426 under the Select from Rejected Batches link. The PDF Cover Sheet can be updated to reflect its approval status as rejected and at the bottom of the Review page 426 a message will appear showing who rejected the entry, from which department and why the entry was rejected.

The user can be required to either Delete the batch and start from scratch or Revise the batch. Since the entry has been rejected, the Preparer can be required to start back on the Journal Detail tab 423 and complete the cover sheet and supporting documentation over again. This is to ensure that any changes the reviewing Approver requested are made.

Once an entry is revised and resubmitted for approval, the prior rejection history can remain on Review tab as will the new pending approvals. This approval history remains with the NMJE until final approval is received so that the full history of the entry is known. The retention of the approval history helps in the situation where different Approvers review the NMJE at different times so that all Approvers can learn about any previous issues another Approver has had so that they can verify that those issues have been corrected.

Should an entry be rejected again this pattern will continue to repeat itself. The entire rejection history will be maintained no matter the number of rejections.

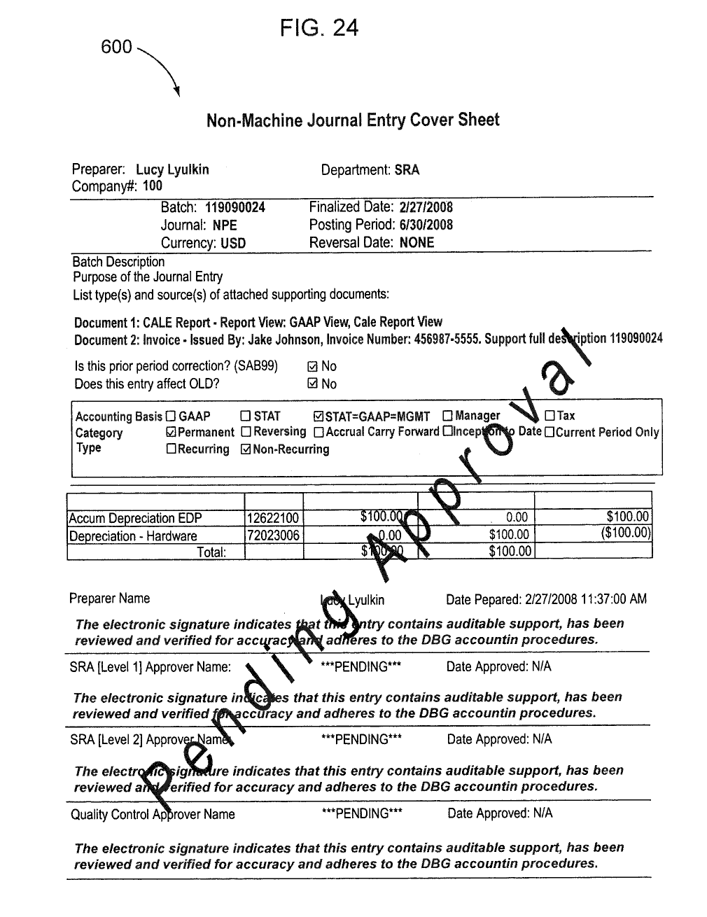

Referring to FIG. 24, an embodiment of a cover sheet 600 is shown. In some embodiments, a PDF cover sheet cannot be generated for an NMJE that does not have supporting documentation attached to it. Once a complete NMJE package is assembled including supporting documentation, a PDF Cover Sheet can be generated. The PDF cover sheet has various stages of completeness to it. As a NMJE goes through each step in the process the cover sheet can be adjusted accordingly to reflect its current approval status.

Prior to submission for approval, the Cover Sheet of a NMJE with finalized support includes a watermark that reads “Pending Approval.” Approval levels will not be listed on the bottom of the entry yet. Supporting documentation can still be modified without requiring rejection or resubmission.

After submission for approval, a cover sheet can be generated and will include a watermark that reads “Pending Approval.” Approval levels will be listed on the bottom of the PDF cover sheet with a ***PENDING*** next to them. Supporting documentation can not be modified anymore.

After an approval is received for the NMJE, the ***PENDING*** at the bottom of the Cover Sheet will be replaced by the approver's name and the date and time the NMJE was approved. The Pending Approval watermark will still appear on the cover sheet if not all approvals have been received. Once all approvals are received for the NMJE, the NMJE will be ready for posting in the Send to General Ledger tab at which point the watermark will be removed.

Should an entry be rejected, the entry will return to the Review tab under the Select from Rejected Entries link and will be watermarked with an Approval Status: REJECTED message. When an entry is rejected, the cover sheet will display the levels of approval that were reached and the explanation from the person that rejected the entry why the entry was rejected. This information can help establish a dialogue between the Preparer and the Approver that rejected the entry to determine why the entry was not approved.

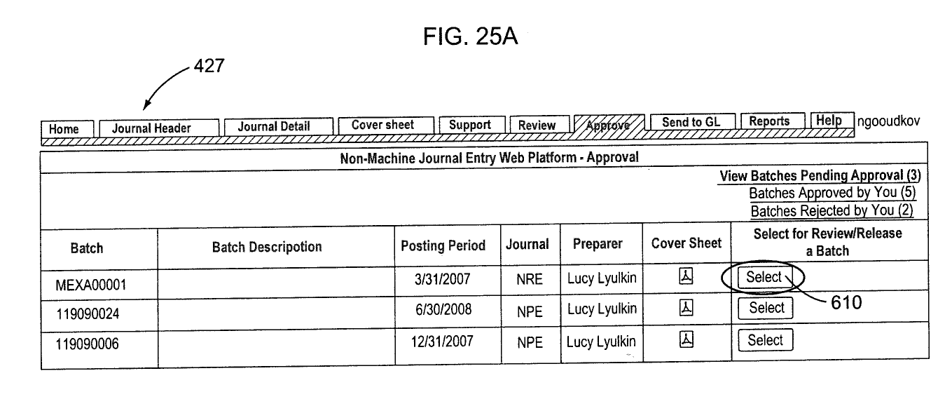

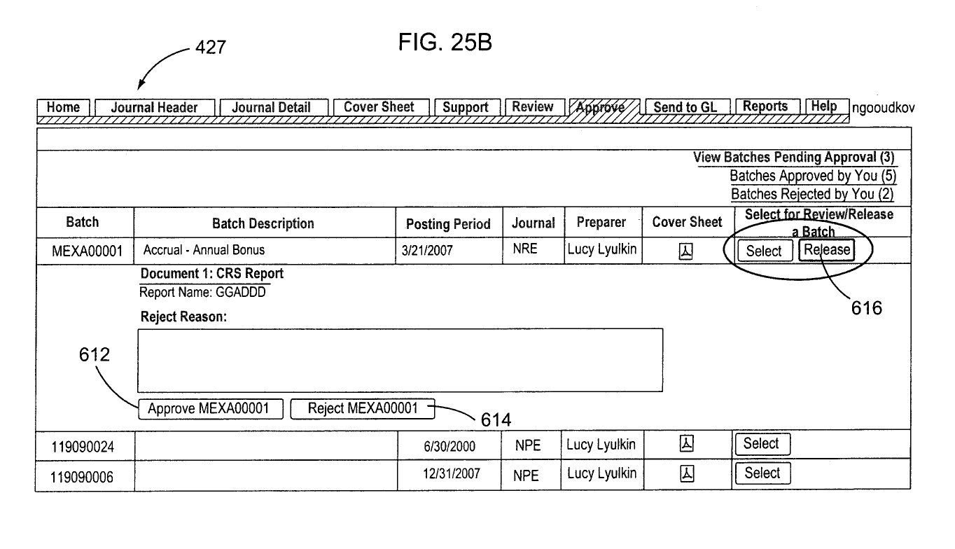

Referring to FIG. 25A, an embodiment of an Approve tab 427 is shown. The NMJE Web Platform has the ability for journal entries to be approved electronically after they have been reviewed. The NMJE application provides the ability to print out all entries and supporting documentation sent to the general ledger in the event that the operator of the NMJE Web Platform requires or desires that paper copies of all journal entries be maintained in addition to approving the entries within the NMJE Web Platform. Entries can not proceed to the general ledger without an Approver logging into the system, viewing the cover sheet and supporting documentation, and approving the entry. The person that electronically approves the entry will be considered the Approver of the NMJE.

The Approve tab 427 can be made available only to users who are given Approver status. The Approvers can preview the Cover Sheet for a selected entry and grant or reject the entry. If an entry is rejected, a rejected reason is required. This entry can be sent back to the Preparer for review.

When an Approver goes to the Approve tab 427, the page can be configured to default to any entries currently pending approval. The page 427 includes three links: (1) Batches Pending Approval; (2) Batches Approved by You; and (3) Batches Rejected by You.

Selecting the View Batches Pending Approval link will launch a comprehensive list of all batches that the Approver can approve for the sub-department(s) for which he is an authorized Approver. Depending on individual circumstances, the Approver can be an approver for one or more sub-departments.

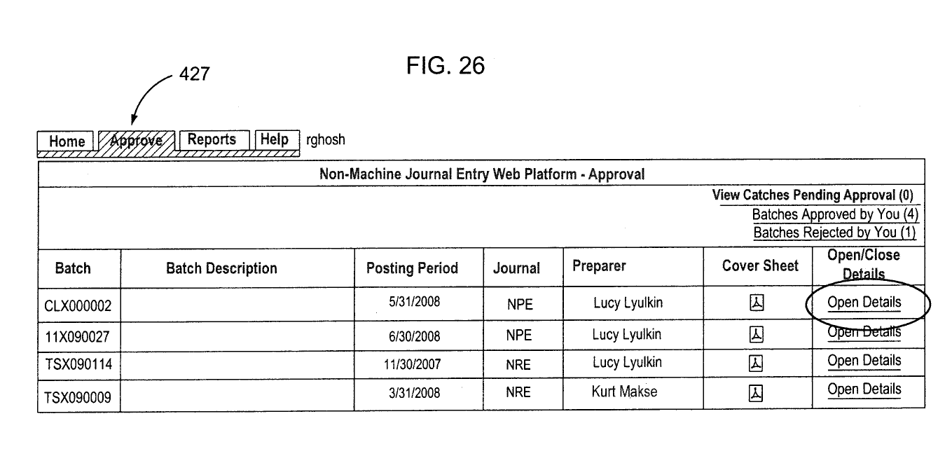

Referring to FIG. 26, an Approver is able to view all batches he has previously approved that have not been posted. Selecting the Batches Approved by You link will launch a list of NMJEs that the Approver has approved. The NMJEs approved by the Approver will remain in this list until they have been sent to the general ledger via the FTP tool or have been rejected by another Approver and then deleted by the preparer thereafter. This list can allow an Approver to ensure that all entries that the Approver has approves are posted.

To view more information about the batch including the rejection history or the approvals pending, an Open Details link on the right hand side of the entry can be selected. If an entry is currently pending approval, the levels of approval still necessary to be obtained can be displayed.

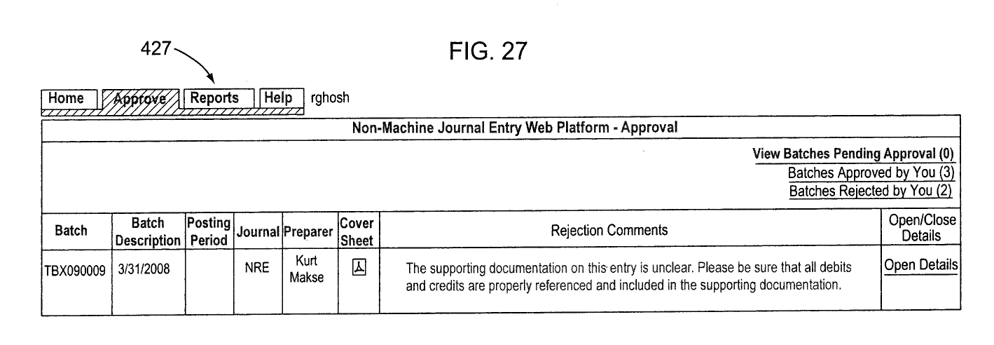

Referring to FIG. 27, selecting the Batches Rejected by You link in the Approve page 427 will launch a list of NMJEs that the Approver has rejected. Entries (with the Approver's rejection comment) will remain under the Batches Rejected by You link until the entry is revised by the Preparer and approved by the same Approver, the revised entry receives all necessary approvals and is FTP'd to the general ledger, or the Preparer deletes the batches from their Journal Detail or Review tab.

Referring to FIG. 25A, to review an entry, the Approver pushes a Select button 610 next to the batch that is wished to view (FIG. 25B). This NMJE becomes locked. The Approver is the only person able to approve, reject or review this batch until the Approver selects an Approve button 612, a Reject button 614, or a Release button 616. This control ensures that multiple Approvers are not reviewing the same batch at the same time. The Release button 616 can be selected to release control over the NMJE. Once it is selected, the Approve and Reject buttons 612, 614 are de-activated for that Approver until that particular NMJE is re-selected.

Once an Approver is in a batch, the Approver can view the supporting documentation and the PDF cover sheet for the entry. Should the Approver determine that the entry has all the necessary documentation to be approved, the Approver pushes the Approve [Batch] button 612. This causes the entry to go to the next person in the approval chain or go to the Preparer to post, depending on which level approver the Approver is for the Preparer.

Should the Preparer determine after reviewing the entry that it does not have the necessary supporting documentation or has another problem, the Approver can reject the entry by selecting the Reject [Batch] button 614. Should the Approver reject the entry, a pop-up window is displayed with a Reject Reason field. The Approver can include information in the Reject Reason field explaining to the Preparer why the entry is being rejected and what steps need to be taken for the entry to be approved. Upon the entry being rejected, the Preparer can receive the entry back to correct the shortcomings and resubmit it for approval again or delete it if it is determined to be unnecessary.

Once an entry is resubmitted after being initially rejected, all rejection history will be available for future approvers. This ensures that approves are made aware of why someone has previously rejected the entry.

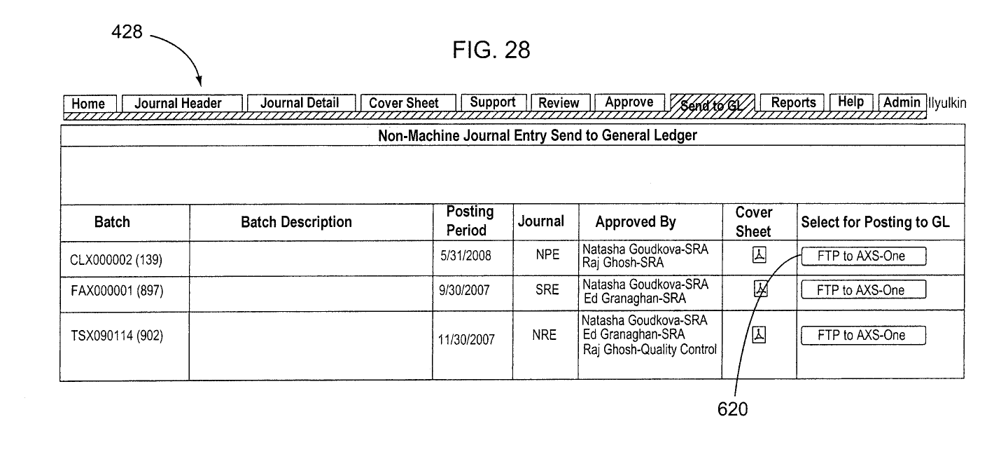

Referring to FIG. 28, an embodiment of a Send to General Ledger tab 428 is shown. Once an NMJE has received all the necessary approvals, the Preparer can send the entry to the AXS-One general ledger and post the entry. The Send to General Ledger tab 428 displays which batches are available to send to the general ledger, indicates who approved the entry, and allow the user to print a finalized PDF cover sheet. The finalized PDF cover sheet no longer has the watermark on it, and it displays who from each department has approved the entry.

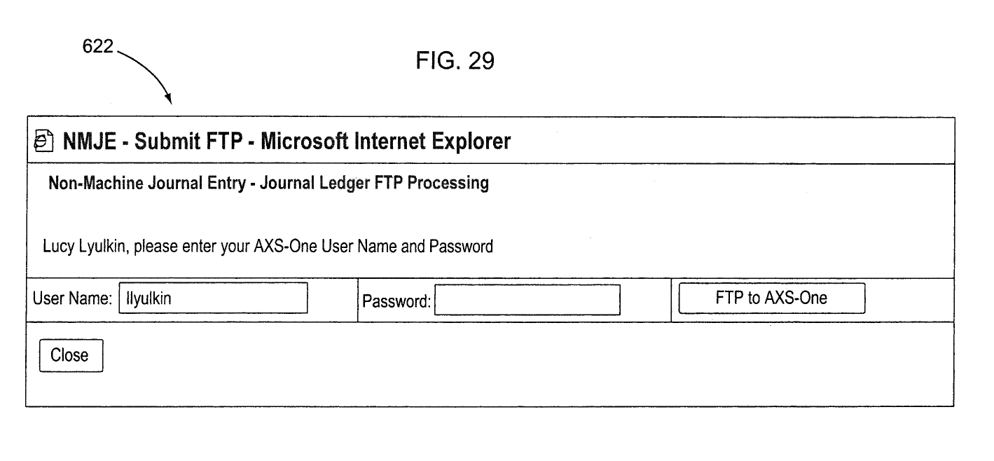

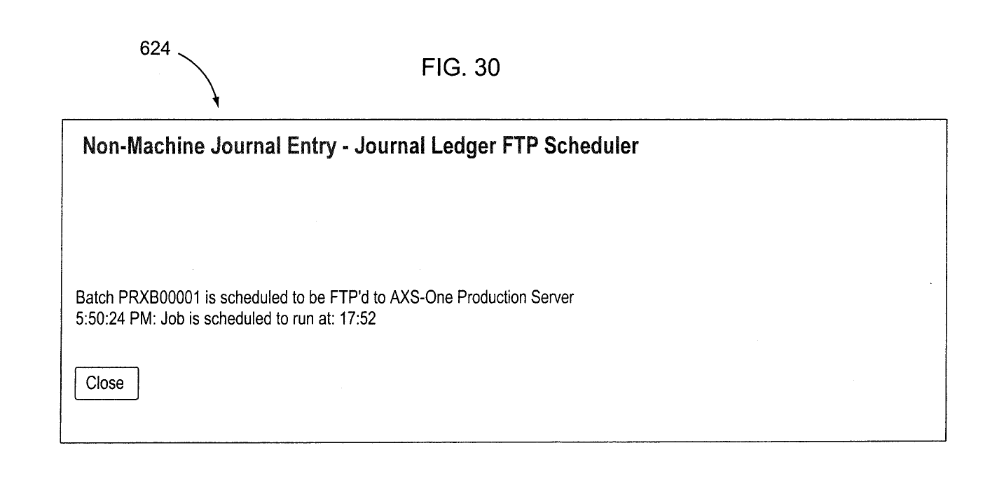

Entries ready for posting can be selected by the Preparer from the Send to General Ledger tab 428. When the Preparer clicks on a FTP to AXS-One button 620, a Submit FTP pop-up box 622 (FIG. 29) becomes available so the Preparer can schedule a journal posting to the general ledger. To schedule an FTP job, the Preparer can be required to enter a valid AXS-One password. The preparer name can pre-set by the system. When the FTP to AXS-One function is selected, the following can take place: (1) the FTP job is scheduled to run on the server; (2) after the job is executed the Journal Posting file is copied to the FTP Server; and (3) the FTP status is displayed on the screen—failed job status will allow the preparer to re-submit Journal Entry. A successfully scheduled NMJE can be verified by the display of an FTP status 624 as shown in FIG. 30.

The Journal Entry Posting can utilize the UPD FTP Submission mode. The UPD submits the GENEX file to the DBGORA Computron database in UPDATE mode. UPDATE mode submissions will modify the Computron database. After the Journal Entry is submitted for posting to the general ledger, an Email is returned to the preparer from the AXS-One system to communicate processing status: posted or failed.

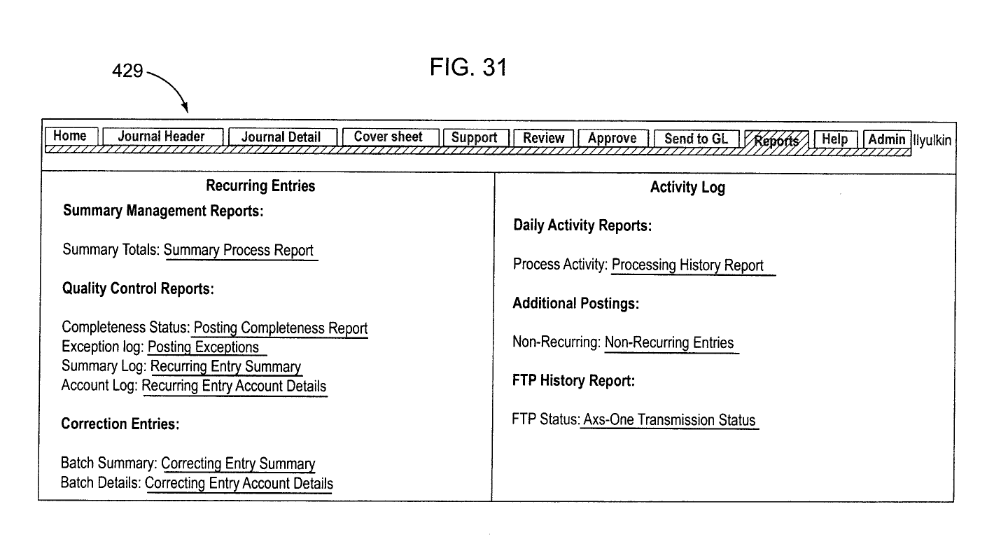

Referring to FIG. 31, an embodiment of a Reports tab 429 is shown. The Reports tab 429 provides a variety of reports on NMJEs processed through the NMJE Web Platform. Application reports are available for preview and download via the Reports Screen. The following reports can be available: summary management reports, quality control reports, correction entries, daily activity reports, additional postings, and FTP history reports.

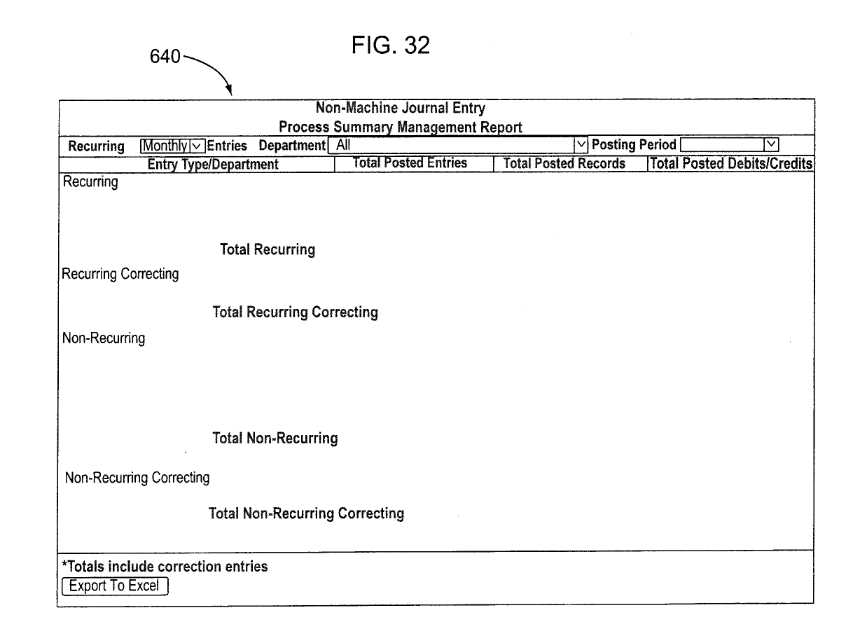

Referring to FIG. 32, a Summary Process report 640 provides management with a high level breakdown of the number and type of journal entries processed through the NMJE Web Platform. Drop-downs allow the user to view Monthly or Quarterly entries for a given department and posting period.

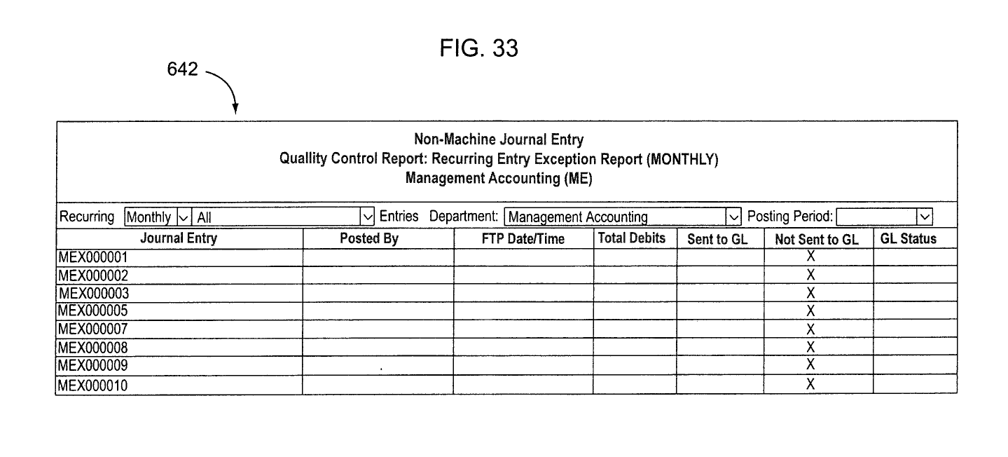

Referring to FIG. 33, a Posting Exceptions report 642 provides management with a list of recurring journal entries processed through the NMJE Web Platform. Drop-downs allow the user to view Monthly or Quarterly entries for a given department and posting period.

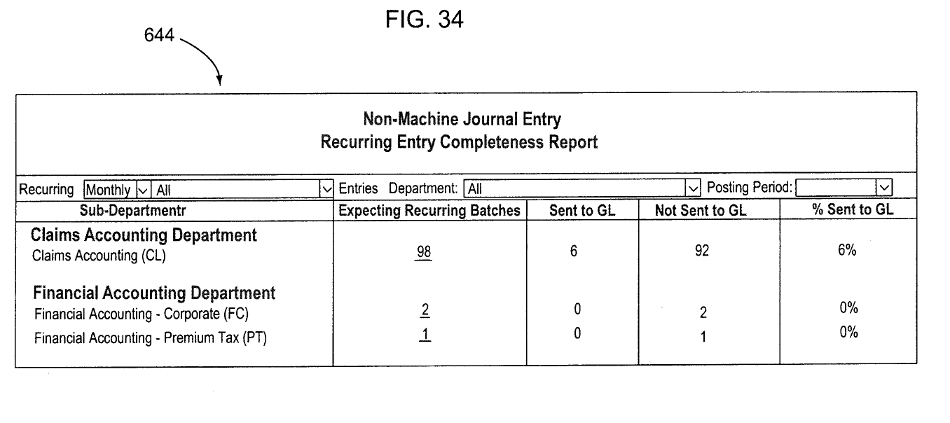

Referring to FIG. 34, a Posting Completeness report 644 provides management with a completeness status of the recurring journal entries processed through the NMJE Web Platform. Drop-downs allow the user to view Monthly or Quarterly entries for a given department and posting period.

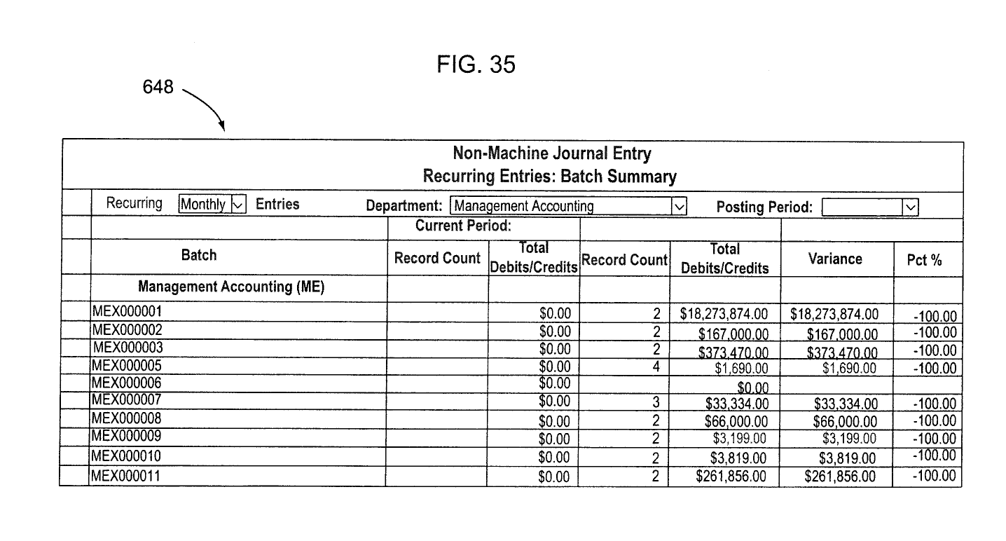

Referring to FIG. 35, a Recurring Entry Summary report 648 provides management with an analytical list of recurring journal entries processed through the NMJE Web Platform. Drop-downs allow the user to view Monthly or Quarterly entries for a given department and posting period.

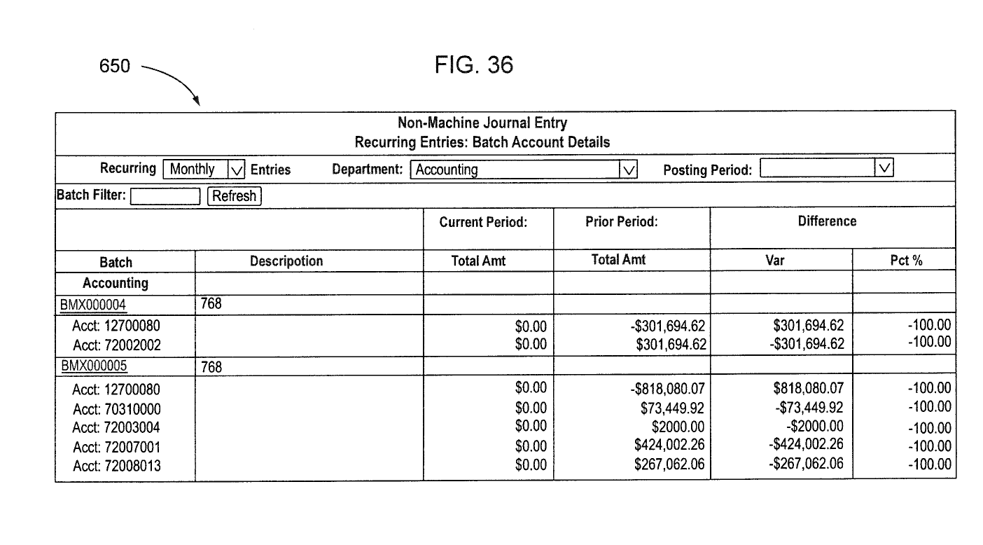

Referring to FIG. 36, a Recurring Entry Account Details report 650 provides management with a detailed analytical list of recurring journal entries processed through the NMJE Web Platform. Drop-downs can allow the user to view Monthly or Quarterly entries for a given department and posting period. The user can click on a specific batch codes (on the left) to see the history of the entry.

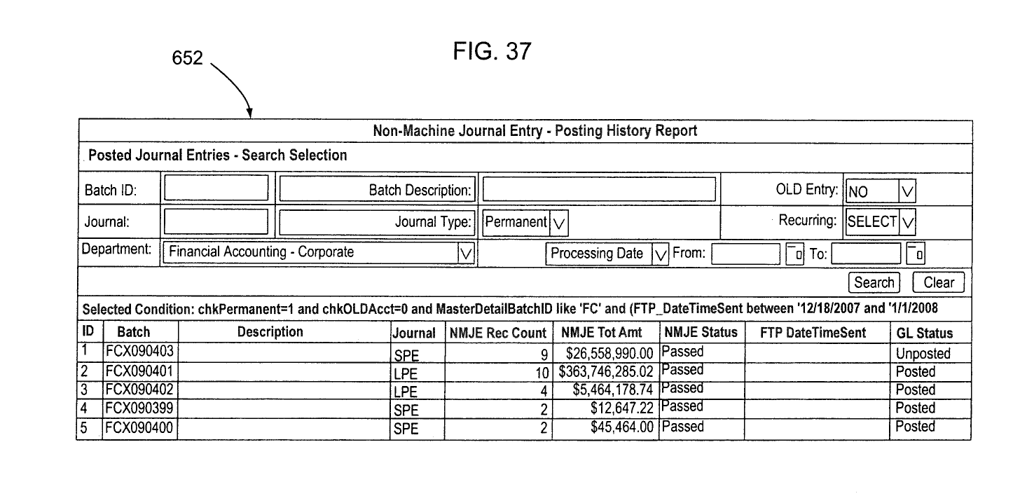

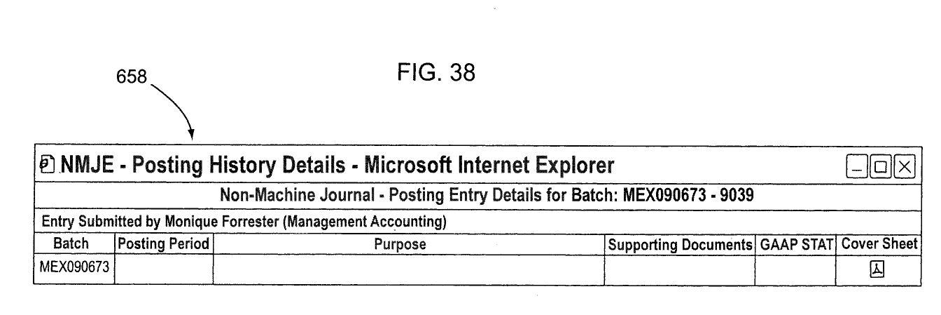

Referring to FIG. 37, a Processing History report 652 provides management with the ability to query any journal entry processed through the NMJE Web Platform. Criteria can be entered into any of the available fields and a search for those criteria can be run by selecting the Search button. An ID number can be selected to see additional information about the journal entry in a new window 654 (FIG. 38). By clicking on the .pdf document in the Cover Sheet box, the user can view the actual journal entry Cover Sheet and Journal Detail. By clicking the .pdf icons next to each support document, the support will be available to open up and view.

Referring to FIG. 37, a Non-Recurring Entries report 658 provides management with the ability to query any non-recurring journal entry processed through the NMJE Web Platform. Criteria can be entered into any of the available fields and a search for those criteria can be run by selecting the Search button. By clicking on the .pdf document in the Cover Sheet box, you can view the actual journal entry Cover Sheet and Journal Detail.

A Correcting Entry Summary report can provide management with an analytical list of corrections of recurring journal entries processed through the NMJE Web Platform. Drop-downs allow the user to view Monthly or Quarterly entries for a given department and posting period

A Correcting Entry Account Details report can provide management with a detailed analytical list of corrections of recurring journal entries processed through the NMJE Web Platform. Drop-downs allow the user to view Monthly or Quarterly entries for a given department and posting period.

The Help tab 430 can provides documentation for the user to help perform a computer-implemented method for posting a non-machine journal entry to a general ledger. The Help tab 430 can include a plurality of links that each launches a help document to aid the user. The links can launch documentation including: Frequently Asked Questions, a training guide, a treaty and WWCC expansion guide, a validation guide, a listing of batch codes, a NMJE procedure, a listing of journal types, and a transaction details template, for example. The Help tab 430 can include an index of help topics with yet other links for each help topic to direct a user to information for the selected help topic.

The Administration tab 4131 can be accessed by an Administrator to perform scheduled maintenance of the NMJE Web Platform. The Administration tab 431 can includes a plurality of conventional maintenance tools as known and used in the art.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited, in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method for posting a non-machine journal entry to a general ledger, the method comprising:
accessing a non-machine journal entry application operated on an accounting processor;
creating a non-machine journal entry using the non-machine journal entry application;
electronically submitting the non-machine journal entry for approval;
reviewing the non-machine journal entry for compliance with a set of requirements;
if the non-machine journal entry complies with the set of requirements, electronically posting the non-machine journal entry to a computer-implemented general ledger application.

2. The computer-implemented method for posting a non-machine journal entry to a general ledger according to claim 1, further comprising:
if the non-machine journal entry does not comply with at least one requirement, revising the non-machine journal entry to comply with the set of requirements; and
re-submitting the revised non-machine journal entry for approval.

3. The computer-implemented method for posting a non-machine journal entry to a general ledger according to claim 1, wherein the non-machine journal entry application is accessed via a web platform.

4. The computer-implemented method for posting a non-machine journal entry to a general ledger according to claim 1, wherein the non-machine journal entry is selected from the group consisting of a recurring entry, a non-recurring entry, and a correcting entry.

5. The computer-implemented method for posting a non-machine journal entry to a general ledger according to claim 1, wherein creating the non-machine journal entry includes:
navigating a journal header module of the non-machine journal entry application to select a journal header from a set of journal header types,
navigating a journal detail module of the non-machine journal entry application to enter journal detail information for the selected journal header,
navigating a cover sheet module of the non-machine journal entry application to create a cover sheet, and
navigating a support module of the non-machine journal entry application to attach supporting documentation for the non-machine journal entry.

6. The computer-implemented method for posting a non-machine journal entry to a general ledger according to claim 1, wherein reviewing the non-machine journal entry for compliance with a set of requirements includes indicating approval of the non-machine journal entry for posting to the general ledger if the non-machine journal entry complies with the set of requirements.

7. The computer-implemented method for posting a non-machine journal entry to a general ledger according to claim 6, wherein approval is indicated by the application of an electronic signature of an authorized approver.

8. A computer-implemented system for posting a non-machine journal entry to a general ledger comprising:
an accounting processor adapted to execute a general ledger application adapted to maintain a general ledger through a plurality of machine entries and a non-machine journal entry application adapted to create a plurality of non-machine journal entries and to selectively transmit non-machine journal entries to the general ledger; and
a data storage device, the data storage device containing accounting information, the data storage device operably arranged with the accounting processor such that the account information in the storage device is accessible to the accounting processor via at least one of the general ledger application the non-machine journal entry application and is modifiable by the accounting processor;
wherein the non-machine journal entry application executed by the accounting processor includes:
a journal header module adapted for use to select a journal header from a set of journal header types,
a journal detail module adapted for use to enter journal detail information for the selected journal header,
a cover sheet module adapted for use to create a cover sheet, and
a support module adapted for use to attach supporting documentation for the non-machine journal entry.

9. The computer-implemented system for posting a non-machine journal entry to a general ledger according to claim 8, wherein the non-machine journal entry application is adapted to selectively transmit non-machine journal entries to the general ledger via an FTP server.

10. The computer-implemented system for posting a non-machine journal entry to a general ledger according to claim 8, wherein the non-machine journal entry application executed by the accounting processor includes a login module adapted for use to access the non-machine journal entry application upon the entry of an authorized identification and an associated password.

11. The computer-implemented system for posting a non-machine journal entry to a general ledger according to claim 8, wherein the non-machine journal entry application executed by the accounting processor includes an approval module adapted for use to review a non-machine journal entry for compliance with a set of predetermined requirements.

12. The computer-implemented system for posting a non-machine journal entry to a general ledger according to claim 11, wherein the non-machine journal entry application executed by the accounting processor includes a submission module adapted for use to send a non-machine journal entry compliant with the set of predetermined requirements to the general ledger maintained by the general ledger application.

13. The computer-implemented system for posting a non-machine journal entry to a general ledger according to claim 12, wherein the non-machine journal entry application executed by the accounting processor includes a reports module adapted for use to generate a plurality of reports concerning the posting of non-machine journal entries to the general ledger.

14. A computer-readable storage medium having instructions stored thereon for creating and posting a non-machine journal entry to a general ledger, the instructions, when executed by a computer, causing the computer to perform the steps of:
selecting a journal header from a set of journal header types for the non-machine journal entry,
associating journal detail information for the selected journal header with the non-machine journal entry,
creating a cover sheet for the non-machine journal entry,
attaching supporting documentation to the non-machine journal entry, and
posting the non-machine journal entry to a computer-implemented general ledger.

15. The computer-readable storage medium according to claim 14, wherein the instructions, when executed by a computer, causing the computer to perform the step of applying an electronic signature of an authorized approver to the non-machine journal entry.
